(19) United States
(12) Patent Application Publication
(10) Pub. No.: US 2026/0005589 A1
(43) Pub. Date: Jan. 1, 2026

(54) ELECTRIC WORK MACHINE AND METHOD OF MANUFACTURING THE SAME

(71) Applicant: MAKITA CORPORATION, ANJO-SHI (JP)

(72) Inventors: Junya INUZUKA, Anjo-Shi (JP); Kei KOUDA, Anjo·shi (JP)

(21) Appl. No.: 19/252,104

(22) Filed: Jun. 27, 2025

(30) Foreign Application Priority Data
Jul. 1, 2024 (JP) 2024-106365
Jun. 23, 2025 (JP) 2025-105579

(51) Int. Cl. H02K 21/16; B25F 5/02; H02K 7/116; H02K 7/14; H02K 9/06

(52) U.S. Cl. CPC H02K 21/16; B25F 5/02; H02K 7/116; H02K 7/145; H02K 9/06; H02K 2213/03

(57) ABSTRACT

In one aspect of the present disclosure, an electric work machine (1) includes a brushless motor (11) having a rotor (40) and a stator (20). The rotor comprises a plurality of permanent magnets (42) disposed such that like poles oppose each other in a circumferential direction of a rotor core (41) and thereby form a plurality of magnetic poles at an outer circumference of the rotor core in the circumferential direction thereof. The number of magnetic poles is 4m (where m is a natural number), and the stator has 3m slots. The rotor rotates at an electric frequency of 1,333 Hz or more.

### CROSS-REFERENCE

This application claims priority to Japanese patent application no. 2024-106365 filed on Jul. 1, 2024, and Japanese patent application no. 2025-105579 filed on Jun. 23, 2025, the contents of which are fully incorporated herein by reference.

### TECHNICAL FIELD

The present disclosure relates to an electric work machine comprising a brushless motor.

### BACKGROUND ART

WO 2008/104156 (A2) discloses an electrically commutated motor that is provided with a permanent-magnet-type rotor. The rotor comprises a plurality of grooves, and a plurality of permanent magnets are respectively disposed in this plurality of grooves.

### SUMMARY OF THE INVENTION

In recent years, brushless motors have been widely adopted as the motive-power source in electric work machines (e.g., in power tools, gardening power tools, etc.). To improve the work efficiency and/or function of electric work machines, there is demand to design and install brushless motors that are both compact and drivable at high speed and with high output (high torque).

Accordingly, it is one non-limiting object of one aspect of the present disclosure to describe techniques for designing an electric work machine in which a brushless motor capable of high-speed rotation and high output is installed while avoiding the need to enlarge the brushless motor.

In the present disclosure, the terms “first,” “second,” etc. are merely intended to distinguish elements from each other and are not intended to limit the order or number of the elements. Accordingly, a first element may be referred to as a “second element” and, similarly, a second element may be referred to as a “first element.” Additionally, the first element may be provided without providing the second element and, similarly, the second element may be provided without providing the first element.

In one aspect of the present disclosure, an electric work machine may comprise a brushless motor and a motive-power transmitting part.

The motive-power transmitting part is configured to (i) have a (driven, drivable, rotatable) tool accessory mounted thereon or a (driven, drivable, rotatable) tool accessory mounted thereon in a detachable manner, and (ii) transmit rotation of the brushless motor to the tool accessory and thereby drive the tool accessory.

The brushless motor comprises a rotor and a stator.

The rotor comprises a rotor core and a plurality of permanent magnets. The permanent magnets may be: (i) mutually spaced apart, preferably equidistantly, in a circumferential direction of the rotor core, and (ii) arranged such that like poles oppose each other in the circumferential direction to thereby form a plurality of magnetic poles in the circumferential direction.

The stator comprises a plurality of coils and a plurality of slots, in which the coils are respectively disposed.

The number of magnetic poles is 4m. The number of slots is 3m. The rotor is configured to rotate at an electric frequency of 1,333 Hz or more. The variable “m” is preferably a natural number (integer) in the range from 1 to 8, e.g., from 1 to 6, e.g., from 2 to 4.

In an electric work machine configured in such a manner, the brushless motor can be driven at high speed with high output (high torque) while avoiding the need to enlarge the brushless motor. Examples of the structures that contribute thereto are at least: (i) the permanent magnet count to the slot count being a ratio of 4:3, and/or (ii) the plurality of permanent magnets being disposed such that like poles oppose each other in the circumferential direction.

In another aspect of the present disclosure, a method of manufacturing an electric work machine may comprise:
preparing a rotor having 4m magnetic poles, wherein the rotor comprises a plurality of permanent magnets, and the permanent magnets are arranged such that like poles oppose each other in a rotational direction of the rotor;
preparing a stator having 3m slots; and
installing in the electric work machine a brushless motor, which comprises the rotor and the stator and is configured to rotate at an electric frequency of 1,333 Hz or more.

Again, the variable “m” is preferably a natural number (integer) in the range from 1 to 8, e.g., from 1 to 6, e.g., from 2 to 4.

An electric work machine manufactured according to such a method can exhibit effects similar to those of the above-mentioned electric work machine.

Incidentally, it is preferable that, in an electric work machine in which such a brushless motor has been installed, the brushless motor has a high power density. The higher the power density is, the more compact and lightweight the brushless motor can become while still supplying the necessary output to the tool accessory for work operations, for which the electric work machine is designed.

Accordingly, in yet another aspect of the present disclosure, an electric work machine may comprise a brushless motor having increased power density, thereby avoiding the need to enlarge the brushless motor.

More specifically, in this aspect of the present disclosure, the electric work machine may comprise:
a brushless motor; and
a motive-power transmitting part configured to (i) have a tool accessory mounted thereon (or operably coupled thereto) or a tool accessory mounted thereon (or operably coupled thereto) in a detachable manner, and (ii) transmit rotation of the brushless motor to the tool accessory and thereby drive the tool accessory;
wherein:
the brushless motor comprises:
   a stator comprising a plurality of coils; and
   a rotor comprising a rotor core and a plurality of permanent magnets; and
the brushless motor is configured to satisfy Equation (1) below.

$$Equation 1$$

$$\frac{R}{{( \frac{V in}{Ne} )}^{2}} < 433 \; 000000 \cdot {Vol}^{- 1.621} \qquad ( 1 )$$

In Equation (1) above:
R is the wire-to-wire resistance value (in m Ω) of the brushless motor based on the plurality of coils;
Vin is the rated-voltage value (V) of the brushless motor;
Ne is the rotational speed (in krpm—i.e. “kilorevolutions per minute”) of the brushless motor when a prescribed effective, induced-voltage value, which indicates (corresponds to) the magnitude of a back EMF generated in the plurality of coils, is equal to the rated-voltage value; and
Vol is the volume (in mm³) of the stator.

The brushless motor of such an electric work machine can be driven with high power density while avoiding the need to enlarge the brushless motor.

### BRIEF DESCRIPTION OF THE DRAWINGS

FIG. 1 is an oblique view of an electric work machine according to an illustrative first embodiment.

FIG. 2 is a first oblique view of a motor inside the electric work machine of the first embodiment.

FIG. 3 is a first exploded, oblique view, which corresponds to the first oblique view, of the motor of the first embodiment.

FIG. 4 is a second oblique view of the motor of the first embodiment.

FIG. 5 is a second exploded, oblique view, which corresponds to the second oblique view, of the motor of the first embodiment.

FIG. 6 is a cross-sectional view taken along line VI-VI of the motor in FIG. 2.

FIG. 7 is a first exploded, oblique view of a rotor of the first embodiment.

FIG. 8 is a second exploded, oblique view of the rotor of the first embodiment.

FIG. 9 is a plan view of a rotor core of the first embodiment.

FIG. 10 is a plan view of the rotor of the first embodiment.

FIG. 11 is an oblique view of the rotor of the first embodiment, in which a resin part is omitted.

FIG. 12 is a side view of the rotor of the first embodiment, in which the resin part is omitted.

FIG. 13 is an explanatory diagram for explaining a process of laminating the rotor core.

FIG. 14 is an explanatory diagram pertaining to a minimum width of a connecting portion of the rotor core.

FIG. 15 is an explanatory diagram illustrating an electrical configuration of the electric work machine of the first embodiment.

FIG. 16 is a graph pertaining to back EMF.

FIG. 17 is a graph showing characteristics of motors designed according to the first embodiment.

FIG. 18 is a graph showing a difference in size between the motor of the first embodiment and a conventional motor.

FIG. 19 is a plan view of the rotor of a second embodiment.

FIG. 20 is a side view of the rotor of the second embodiment, in which the resin part is omitted.

FIG. 21 is a plan view of the rotor of a third embodiment.

FIG. 22 is an oblique view of a stator and the rotor of the motor of a fourth embodiment.

### DETAILED DESCRIPTION OF THE INVENTION

### 1. Summary of Embodiments

Certain embodiments according to the present teachings may be provided that comprise one or more of the following.
Feature 1: A brushless motor.
Feature 2: A motive-power transmitting part.
Feature 3: The motive-power transmitting part is configured to have a tool accessory mounted thereon or a tool accessory mounted thereon in a detachable manner.
Feature 4: The motive-power transmitting part is configured to transmit rotation of (rotational energy output by) the brushless motor to the tool accessory and thereby drive the tool accessory.
Feature 5: The brushless motor comprises a rotor.
Feature 6: The rotor comprises a rotor core.
Feature 7: The rotor comprises a plurality of permanent magnets.
Feature 8: The permanent magnets are disposed at least partially in the interior of the rotor core. The permanent magnets may be disposed at least partially in the rotor core. The permanent magnets may be at least partially embedded in the rotor core.
Feature 9: The permanent magnets are mutually spaced apart, preferably equidistantly, in a circumferential direction of the rotor core. The circumferential direction of the rotor core may also be expressed in different words as, e.g., (i) the rotational direction of the rotor core, (ii) the rotational direction of the rotor, (iii) the circumferential direction of the rotor, or (iv) the rotational direction of the brushless motor, all of which are intended to be synonymous with each other.
Feature 10: The permanent magnets are arranged such that like poles oppose each other in the circumferential direction of the rotor core.
Feature 11: The permanent magnets form a plurality of magnetic poles along (around) the circumferential direction of the rotor core. The plurality of magnetic poles may be formed by arranging the permanent magnets according to at least the above-mentioned Feature 10.
Feature 12: The brushless motor comprises a stator.
Feature 13: The stator comprises a plurality of coils.
Feature 14: The stator has a plurality of slots.
Feature 15: Portions of the coils are respectively disposed in the slots.
Feature 16: The number of magnetic poles is 4m (where m is a natural number). Here, the term “4m” means the multiplication product of 4 and m. The expression “having 4m magnetic poles” has the same meaning as “the number of permanent magnets is 4m”.
Feature 17: The number of slots is 3m. Here, the term “3m” means the multiplication product of 3 and m. The expression “having 3m slots” may also be expressed in other words, such as “the number of coils is 3m”.
Feature 18: The rotor is configured to rotate at an electric frequency of 1,333 Hz or more. The electric frequency may be defined as an integrated value resulting from integrating the rotational speed of the rotor (in other words, the rotational speed of the rotor core or the rotational speed of the brushless motor) per second and the pole-pairs count. The pole-pairs count is ½ (one-half) the number of magnetic poles.

In an electric work machine comprising at least Features 1-7 and 9-18, the brushless motor can be driven at high speed with high output while avoiding the need to enlarge the brushless motor.

The expressions “the plurality of magnetic poles having 4m magnetic poles” and
“the number of magnetic poles is 4m” mean that the plurality of magnetic poles has exactly 4m magnetic poles and does not encompass exceeding 4m magnetic poles.

Similarly, the expressions “the plurality of slots having 3m slots” and “the number of slots is 3m” mean that the plurality of slots has exactly 3m slots and does not encompass exceeding 3m slots.

Accordingly, in embodiments in which, for example, m=2, the brushless motor has eight magnetic poles and six slots and does not have nine or more magnetic poles and does not have seven or more slots.

The plurality of permanent magnets may comprise 4m permanent magnets.

Each of the permanent magnets may be divided into a plurality of partial permanent magnets. Each of the permanent magnets may be divided, for example, along a radial direction or may be divided, for example, along an axial direction. The radial direction is a direction perpendicular to the rotational axis of the rotor (in other words, the rotational axis of the rotor core). The axial direction is a direction along (i.e., parallel to or coinciding with) the rotational axis of the rotor.

The electric work machine may comprise a controller (or a control circuit). The controller may be configured to supply electric power (current) to the brushless motor so that the brushless motor rotates at the electric frequency of 1,333 Hz or more. For example, the rated electric frequency of the brushless motor may be 1,333 Hz or more, or the electric frequency when the brushless motor is rotating at the maximum rotational speed while the electric work machine is being used may be 1,333 Hz or more.

In addition to or instead of at least any one of Features 1-18 described above, certain embodiments according to the present teachings may comprise one or more of the following.
Feature 19: The rotor core comprises a plurality of core sheets.
Feature 20: Each of the core sheets includes (or is composed of) a sheet-shaped soft magnetic material.
Feature 21: The core sheets are laminated together along the rotational axis of the rotor.
Feature 22: The thickness of each of the core sheets in the direction along the rotational axis is greater than 0 mm and 0.35 mm or less.

In an electric work machine comprising at least Features 1-22, losses (e.g., losses owing to eddy currents) arising in the rotor core are reduced. Thereby, it becomes possible to further increase the rotational speed and/or the output of the brushless motor. It is noted that the term “rotational speed” means the number of rotations per unit of time (e.g., per minute or per second). The rotational speed may also be expressed in different words, e.g., as the rotational rate.

In addition to or instead of at least any one of Features 1-22 described above, certain embodiments according to the present teachings may comprise the following.
Feature 23: The thickness of each of the core sheets is 0.30 mm or less.

In an electric work machine comprising at least Features 1-23, the rotational speed and/or the output of the brushless motor can be further increased compared with embodiments in which the thickness of each of the core sheets is greater than 0.30 mm.

In addition to or instead of at least any one of Features 1-23 described above, certain embodiments according to the present teachings may comprise the following.
Feature 24: The thickness of each of the core sheets is 0.25 mm or less.

Thus, in an electric work machine having at least Features 1-24, the rotational speed and/or the output of the brushless motor can be further increased compared with embodiments in which the thickness of each of the core sheets is greater than 0.25 mm.

It is noted that the thickness of each of the core sheets may be 0.23 mm or less or may be 0.20 mm or less. In addition, the thickness of each of the core sheets may be greater than 0 mm or may be a prescribed lower-limit thickness. The lower-limit thickness is greater than 0 mm. For example, and without limitation, the lower limit of the thickness of the core sheets may be, e.g., 0.05 mm or 0.10 mm.

In addition to or instead of at least any one of Features 1-24 described above, certain embodiments according to the present teachings may comprise one or more of the following.
Feature 25: Each of the core sheets has a first surface.
Feature 26: A protruding portion (protrusion) is provided on the first surface.
Feature 27: Each of the core sheets has a second surface.
Feature 28: A recessed portion (recess) is provided on the second surface at a location of the second surface that overlaps (is aligned with) the protruding portion in the axial direction.
Feature 29: The core sheets are laminated (held) together by inserting the protruding portion of one of two mutually opposing core sheets into the corresponding recessed portion of the other of the two mutually opposing core sheets.

In an electric work machine comprising at least Features 1-22 and 25-29, it becomes possible to improve the quality and reliability of the rotor core. Specifically, the plurality of core sheets can be laminated securely and precisely during the process of manufacturing the rotor core.

The recessed portions and the protruding portions may be configured so that the protruding portions can no longer detach (or tend not to detach) from the recessed portions owing to the pressure (and/or the frictional force) acting on each recessed portion from the corresponding protruding portion inserted therein. Each of the protruding portions may be clinched to the corresponding recessed portion by being inserted into the recessed portion. More specifically, the protruding portions and/or the recessed portions may be mechanically deformed owing to the pressure received from each of the protruding portions being inserted into the corresponding recessed portion. Each of the protruding portions may be clinched to the corresponding recessed portion by that mechanical deformation.

In addition to or instead of at least any one of Features 1-29 described above, certain embodiments according to the present teachings may comprise one or more of the following.
Feature 30: The rotor core has a plurality of holes.
Feature 31: The holes are disposed (arranged) mutually spaced apart, preferably equidistantly, in the circumferential direction.
Feature 32: Each of the holes has one of the permanent magnets, from among the plurality of permanent magnets, inserted therein; i.e. the permanent magnets are respectively disposed in the holes.

In an electric work machine comprising at least Features 1-18 and 30-32, the plurality of permanent magnets can be securely and efficiently fixed to the rotor core. It is noted that each of the holes may partially or completely pass through in the axial direction of the rotor core.

In addition to or instead of at least any one of Features 1-32 described above, certain embodiments according to the present teachings may comprise one or more of the following.
Feature 33: The rotor core comprises a circular-tube-shaped core ring.
Feature 34: The rotor core comprises a plurality of magnet-support parts.
Feature 35: The magnet-support parts are disposed (arranged) mutually spaced apart, preferably equidistantly, in the circumferential direction.
Feature 36: With regard to the plurality of magnet-support parts, between two of the circumferentially adjacent magnet-support parts, there is one corresponding hole among the plurality of holes; i.e. each hole is disposed between two circumferentially-adjacent ones of the magnet-support parts.
Feature 37: The rotor core has a plurality of connecting portions.
Feature 38: The plurality of connecting portions is provided corresponding to the plurality of magnet-support parts, respectively; i.e. the number of connecting portions is proportional, preferably equal, to the number of magnet-support parts.
Feature 39: Each of the connecting portions connects one of the magnet-support parts to the core ring.
Feature 40: The width at the portion of each of the connecting portions at which the width is smallest is 0.4-0.6 mm; i.e. the smallest (narrowest) width of any portion of the connecting portions is in the range from 0.4 to 0.6 mm. The width is a length in a direction perpendicular to both the axial direction and the radial direction. In other words, the width of the smallest portion of the connecting portions extends perpendicular to the rotational axis of the rotor and to the radial direction of the rotor.

In an electric work machine having at least Features 1-18 and 30-40, magnetic-flux short circuits (in more detail, magnetic-flux short circuits via the above-mentioned plurality of connecting portions) within the rotor core can be reduced while maintaining a suitable strength of the rotor core.

In addition to or instead of at least any one of Features 1-40 described above, certain embodiments according to the present teachings may comprise one or more of the following.
Feature 41: The rotor core has a plurality of openings.
Feature 42: The openings are disposed (arranged) mutually spaced apart, preferably equidistantly, in the circumferential direction at (along) an outer-circumferential surface of the rotor core.
Feature 43: Each of the openings is connected to one corresponding hole among the plurality of holes, and thereby is exposed from the rotor core toward the radial direction of the rotor core; i.e. the openings are on a radially outer side of the rotor core or are gaps in the outer circumferential surface of the rotor core.

Assume, for example, that the plurality of openings is not provided and that portions of the rotor core are also present in the regions where the plurality of openings (opening corresponding regions, below) would be. In such an embodiment, a portion of each of the magnetic fluxes from the plurality of permanent magnets would short circuit through the opening corresponding region; thereby, there is the possibility that said portion of the magnetic flux can no longer be used effectively for motor output (i.e. for driving the rotor).

In contrast, by providing the plurality of openings, the reluctance in each of the opening corresponding regions increases and magnetic-flux short circuits through the opening corresponding region decrease.

Consequently, in an electric work machine comprising at least Features 1-18, 30-32, and 41-43, it becomes possible to reduce the reluctance of the rotor core and to more effectively use the magnetic fluxes from the plurality of permanent magnets for motor output (for driving the rotor). Thereby, it is further possible to increase the rotational speed and/or the output of the motor.

In addition to or instead of at least any one of Features 1-43 described above, certain embodiments according to the present teachings may comprise the following.
Feature 44: The brushless motor is configured to satisfy Equation (1) below.

$$Equation 1$$

$$\frac{R}{{( \frac{V in}{Ne} )}^{2}} < 433 \; 000000 \cdot {Vol}^{- 1.621} \qquad ( 1 )$$

In Equation (1) above:
R is the wire-to-wire resistance value (in m Ω) of the brushless motor based on the plurality of coils;
Vin is the rated-voltage value (V) of the brushless motor;
Ne is the rotational speed (in krpm) of the brushless motor when a prescribed effective, induced-voltage value, which indicates (corresponds to) the magnitude of a back EMF generated in the plurality of coils, is equal to the rated-voltage value; and
Vol is the volume (in mm³) of the stator.

The effective, induced-voltage value may be, for example, the effective value of the back EMF generated in any coil of the plurality of coils or may be an average value of the absolute values of the back EMF of all the coils. In addition, the effective induced voltage may be, for example, the average value of the effective induced voltage generated within an electrical-angle range determined in advance for any of the coils. The electrical-angle range determined in advance may be a range for a prescribed angle (e.g., 60°) centered on the electrical angle at which the back EMF is the maximum value. In an embodiment in which the back EMF at, for example, 90° is taken as the maximum value, the electrical-angle range may be, for example, 60°-120°.

In an electric work machine comprising at least Features 1-18 and 44, the brushless motor can be driven with high power density while avoiding the need to enlarge the brushless motor.

An embodiment having the above-mentioned Feature 44 may also comprise, in addition to Feature 44, any feature from among the above-mentioned Features 1-43. Certain embodiments may comprise, for example, Features 1, 5-7, 12, 13, and 44. Such an embodiment is referred to as a specific combination. In an electric work machine having such a specific combination as well, the brushless motor can be driven with high power density while avoiding the need to enlarge the brushless motor.

The above-mentioned specific combination may further comprise another one or more features. The above-mentioned specific combination may further comprise, for example, at least one of: (i) Features 9-11; (ii) Feature 16; (iii) Feature 17; and/or (iv) Feature 18.

In an embodiment in which the above-mentioned feature combination further comprises Features 9-11, the rotor can be caused to generate an even greater magnetic flux, and thereby it becomes possible to increase the rotational speed and output of the brushless motor in an electric work machine configured in such a manner.

In an embodiment in which the above-mentioned feature combination further comprises Features 9-11, 16, and 17, it becomes possible to make the brushless motor even more compact while realizing the desired rotational speed as well as the desired output and/or the desired power density in an electric work machine configured in such a manner.

In an embodiment in which the above-mentioned feature combination further comprises Features 9-11 and 16-18, the compact brushless motor can be rotated at a high speed, increasing the work efficiency of the electric work machine configured in such a manner.

In addition to or instead of at least any one of Features 1-44 described above, certain embodiments according to the present teachings may comprise one or more of the following.
Feature 45: The brushless motor comprises three terminals.
Feature 46: The three terminals are electrically connected to the plurality of coils and are configured to provide electric power (drive currents) to the plurality of coils.

If an embodiment comprises Features 44 46, then R in the above-mentioned Equation (1) may be the inter-terminal resistance value between any two of the three terminals. This resistance value may be referred to as the “wire-to-wire resistance value” or a “motor-resistance value”. In addition, in such an embodiment, the effective, induced-voltage value, which defines Ne in the above-mentioned Equation (1), may be the above-mentioned effective value or the above-mentioned average value of the back EMF generated between any two of the three terminals, or may be the average value of the back EMF generated within the above-mentioned electrical-angle range between any two of the terminals.

The electric work machine may comprise an electric power generating circuit for generating electric power (or a drive circuit or a controller). The electric power may be in the form of three-phase electric power (three-phase electric current). In such an embodiment, the three terminals may be: (i) electrically connected to the electric power generating circuit; (ii) configured to receive electric power (current) from the electric power generating circuit; and (iii) configured to supply the received electric power (current) to the plurality of coils.

In addition to or instead of at least any one of Features 1-46 described above, certain embodiments according to the present teachings may comprise the following.
Feature 47: The stator comprises a circular-tube-shaped stator core.

If an embodiment comprises Features 44 and 47, then Vol in the above-mentioned Equation (1) may be the volume of the stator core. Specifically, Vol may be an integrated value resulting from integrating the surface area of a core-end circle over the core length. The core-end circle is a circle in which the outer diameter of the stator core is taken as the diameter. The core length is the length of the stator core along the axial direction.

In addition to or instead of at least any one of Features 1-47 described above, certain embodiments according to the present teachings may comprise one or more of the following.
Feature 48: The number of magnetic poles is eight.
Feature 49: The number of slots is six.

In other words, the above-mentioned Features 48 and 49 correspond to “m=2” in the above-mentioned Features 16 and 17.

In an electric work machine comprising at least Features 1-18, 48, and 49, the cost, size (and/or weight), and the rotational speed and output of the brushless motor can be maintained at an overall desired level.

In addition to or instead of at least any one of Features 1-49 described above, certain embodiments according to the present teachings may comprise the following.
Feature 50: The brushless motor is configured to rotate at a rotational speed of 20,000 rpm or more.

The electric work machine may be configured to control the brushless motor such that the brushless motor rotates at the rotational speed of 20,000 rpm or more. For example, the rated rotational speed of the brushless motor may be 20,000 rpm or more, or the maximum rotational speed of the brushless motor when using the electric work machine may be 20,000 rpm or more. It is possible to improve the work efficiency of the electric work machine for an electric work machine comprising at least Features 1-18 and 50.

In addition to or instead of one or more of Features 1-50 described above, certain embodiments according to the present teachings may comprise the following.
Feature 51: The permanent magnets respectively extend in radial directions of the rotor core; i.e. a longest dimension of each of the permanent magnets extends radially with respect to the rotational axis of the rotor core.

The length of each of the permanent magnets in the radial direction may be longer than the length thereof in the circumferential direction. Preferably, the length of each of the permanent magnets in the radial direction is also longer than the length thereof in the axial direction. For example, each of the permanent magnets may have a sheet, plate or block (polyhedron) shape, and a sheet (plate, block) surface thereof may be parallel to the axial direction and parallel to the radial direction. In other words, each of the permanent magnets may have a rectangular shape in a cross-section orthogonal to the rotational axis of the rotor core, wherein the longest dimension of the rectangle extends radially or at least substantially radially.

In an electric work machine comprising at least Features 1-18 and 51, the plurality of permanent magnets (in other words, the plurality of magnetic poles) can be caused to generate an even greater magnetic flux, and thereby it becomes possible to further increase the rotational speed and/or output of the brushless motor.

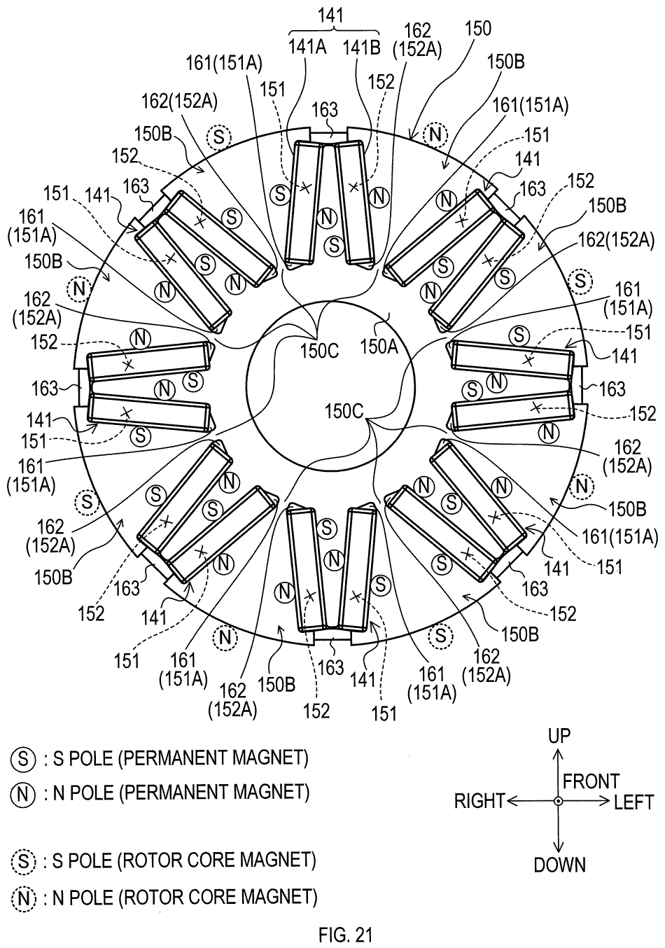

In addition to or instead of at least any one of Features 1-51 described above, certain embodiments according to the present teachings may comprise one or more of the following.
Feature 52: Each of the permanent magnets includes a first partial magnet and a second partial magnet.
Feature 53: The first partial magnet and the second partial magnet are spaced apart from each other in the circumferential direction; i.e. the first and second partial magnets do not touch each other.
Feature 54: The first partial magnet and the second partial magnet are disposed (arranged) such that unlike poles oppose (face) each other in the circumferential direction (as can be seen, e.g., in FIG. 21).

In an electric work machine comprising at least Features 1-18 and 52-54, it becomes possible to increase the magnetic flux generated by each of the permanent magnets. More specifically, the first partial magnet and/or the second partial magnet can be disposed (arranged, caused to extend) along a direction tilted from the radial direction, e.g., within a range of ±20°, e.g., ±15°, e.g., ±10°. Thereby, it is possible to increase the surface area (in more detail, the surface area of the magnetic pole) of the plurality of permanent magnets, and thereby it becomes possible to reduce the size of the brushless motor commensurately.

In addition to or instead of at least any one of Features 1-54 described above, certain embodiments according to the present teachings may comprise one or more of the following:
Feature 55: A grip portion configured to be gripped by a user of the electric work machine.
Feature 56: A battery-mounting part configured to have a battery pack, which comprises a battery, mounted thereon in a detachable manner.

In an electric work machine comprising at least Features 1-18, 55, and 56, it is possible to provide a handheld, battery-driven-type electric work machine that realizes high-speed rotation and/or high output while being compact.

In certain embodiments according to the present teachings, an electric-work-machine manufacturing method may comprise one or more of the features below.
Feature 57: Preparing a rotor having 4m (where m is a natural number) magnetic poles. The rotor may comprise a plurality of permanent magnets. The plurality of permanent magnets may be disposed (arranged) such that like poles oppose each other in the circumferential direction of the rotor.
Feature 58: Preparing a stator having 3m slots.
Feature 59: Installing, in the electric work machine, a brushless motor comprising the rotor of Feature 57 and the stator of Feature 58, wherein the rotor is configured to rotate at an electric frequency of 1,333 Hz or more.

According to a method comprising at least Features 57-59, the brushless motor can be driven at high speed with high output while avoiding the need to enlarge the brushless motor.

Examples of the electric work machine described above include various apparatuses configured to be used at work sites such as in building construction, manufacturing, gardening, civil engineering, or the like, specifically: power tools for masonry, metalworking, and carpentry; power tools for gardening; power tools for preparing the environment of the work site; a fan vest; a fan jacket; a hand cart; an electric power assisted bicycle; an inflator; or the like.

Examples of the power tools described above include a power chain saw, a power handy saw, a power blower, a power hammer, a power hammer drill, a power drill, a power driver, a power wrench, a power impact driver, a power impact wrench, a power grinder, a power circular saw, a power reciprocating saw, a power jigsaw, a power cutter, a power plane, a power nailing machine (including a tacker), a power hedge trimmer, a power lawnmower, a power lawn clipper, a power brush cutter, a power cleaner, a power sprayer, a power spreader, a power dust collector (vacuum cleaner), a power trowel, a power vibrator, a power rammer, a power compactor, a power pump, a power pile driver, a power concrete saw, a power screed, a power cut-off saw, and the like.

Examples of the electric work machines described above may be in the form of a battery-driven-type apparatus configured to be driven (powered) by a battery. Specifically, the examples of the electric work machine described above may have the battery built in or may be configured so that a battery pack is mounted thereon in a detachable manner. The battery pack houses the battery.

In certain embodiments according to the present teachings, the above-mentioned Features 1-59 may be combined in any manner.

In certain embodiments, any of the above-mentioned Features 1-59 may be excluded.

### 2. Specific Illustrative Embodiments

### 2-1. First Embodiment

A specific illustrative embodiment will be explained below. In this specific illustrative embodiment, an electric work machine 1, which is configured as a power impact driver, is provided. However, this kind of electric work machine 1 is merely one example, and the present disclosure can be applied to an electric work machine of any form, as was explained above, that comprises an electric motor.

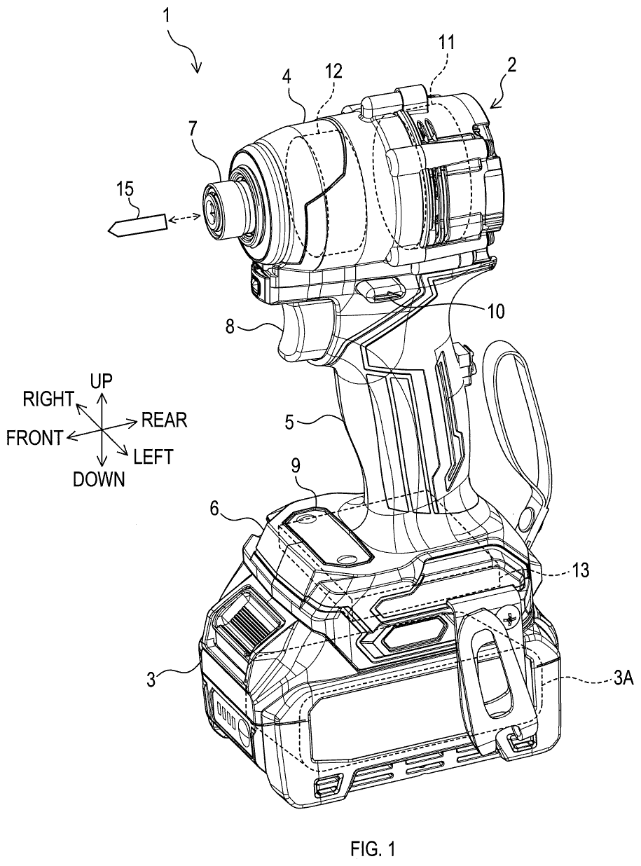

For the sake of convenience in explanation, the directions “up,” “down,” “front,” “rear,” “left,” and “right” are defined in the following explanation and drawings as shown in FIG. 1 and the like. However, these directions are employed merely for facilitating an understanding of the structure of the electric work machine 1 and are not intended to limit the orientation of the electric work machine 1. The electric work machine 1 can be oriented in any direction.

### 2-1-1. Overall Configuration of the Illustrative Electric Work Machine

As shown in FIG. 1, the electric work machine 1 according to one representative, non-limiting embodiment of the present teachings comprises a work-machine main body 2. The work-machine main body 2 comprises a housing 4. The housing 4 houses a brushless motor (hereinbelow, abbreviated as “motor”) 11 in the interior thereof.

The housing 4 houses a first power-transmission part 12 in the interior thereof. The first power-transmission part 12 is disposed forward of a motor 11 and is mechanically coupled to the motor 11.

A second power-transmission part 7 is provided at a front end of the housing 4. The second power-transmission part 7 is mechanically coupled to the first power-transmission part 12. The second power-transmission part 7 may also be called a chuck sleeve.

A tool accessory 15 (e.g., a drivable, e.g., rotatable, tool accessory 15) is mounted on (in) the second power-transmission part 7 in a detachable manner. In the present first embodiment, the tool accessory 15 may be configured as, for example, a variety of types of tool bits. Examples of the various kinds of tool bits include: a driver bit; a socket bit; and a drill bit.

The first power-transmission part 12 transmits the rotational energy generated by the motor 11 to the second power-transmission part 7. Consequently, when the rotor 40 of the motor 11 rotates, the second power-transmission part 7 rotates together with the tool accessory 15, which is mounted thereon. In addition, the first power-transmission part 12 includes an impact (hammer) mechanism (not shown), e.g., a hammer/anvil mechanism. When the magnitude of the load applied from the second power-transmission part 7 exceeds a prescribed level, the impact mechanism intermittently applies an impact force to the second power-transmission part 7 in the rotational direction; e.g., a hammer repeatedly strikes an anvil in the rotational direction of the tool accessory 15 in order to apply a greater amount of torque to the tool accessary 15. The load is applied in a reverse direction of the rotational direction of the second power-transmission part 7. This impact mechanism realizes the characteristic function of an impact driver.

The work-machine main body 2 comprises a grip 5, which extends downward from the housing 4. The grip 5 is configured to be gripped by the user of the electric work machine 1 when performing work using the electric work machine 1.

The work-machine main body 2 comprises a trigger 8. The trigger 8 is provided at an upper-end front side of the grip 5. The trigger 8 is manually moved (for example, is pulled) from its initial position by the user. The motor 11 is stopped when the trigger 8 is at the initial position. The motor 11 rotates when the trigger 8 is moved away from its initial position. A reversing switch lever 10 is provided to switch the rotational direction of the motor 11.

The work-machine main body 2 comprises a battery-mounting part 6. The battery-mounting part 6 is provided at a lower end of the grip 5. A battery pack 3 is mounted on the battery-mounting part 6 in a detachable manner. FIG. 1 shows the state in which the battery pack 3 is mounted on the battery-mounting part 6. The battery pack 3 comprises a battery 3A.

The work-machine main body 2 comprises an operation panel 9 on an upper surface of the battery-mounting part 6. The operation panel 9 is configured to be manipulated by the user. The user can specify (select, set) an action mode for the motor 11 via (using) the operation panel 9. The user can also specify (select, set) the torque output to be applied to the tool accessory 15, e.g., when tightening a screw or bolt, via (using) the operation panel 9.

The work-machine main body 2 houses a controller 13 downward of the grip 5 and upward of the battery-mounting part 6. When the battery pack 3 is mounted on the battery-mounting part 6, the battery 3A is electrically connected to the controller 13. The controller 13 receives battery power (current) from the battery 3A and operates based on (using) the battery power. When the trigger 8 is manually operated (moved, squeezed), the controller 13 converts the battery power into motor-drive electric power (drive currents) and supplies such to the motor 11. The motor 11 rotates upon receiving the motor-drive electric power. The motor-drive electric power is in the form of three-phase electric power (current). The controller 13 controls the motor-drive electric power in accordance with the amount of movement of the trigger 8 and the action mode that is currently set (and the torque limit, if set), and thereby controls the rotational speed of the motor 11.

### 2-1-2. Overall Configuration of the Motor

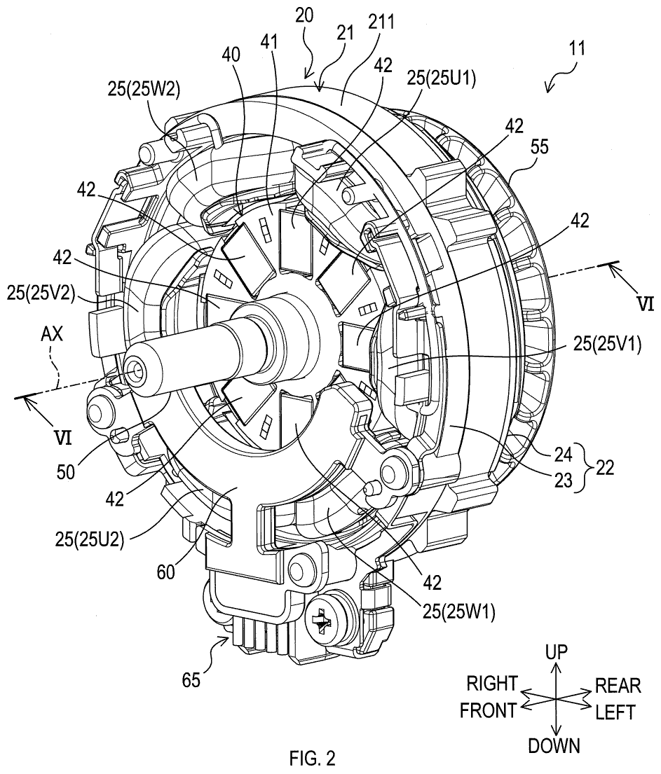

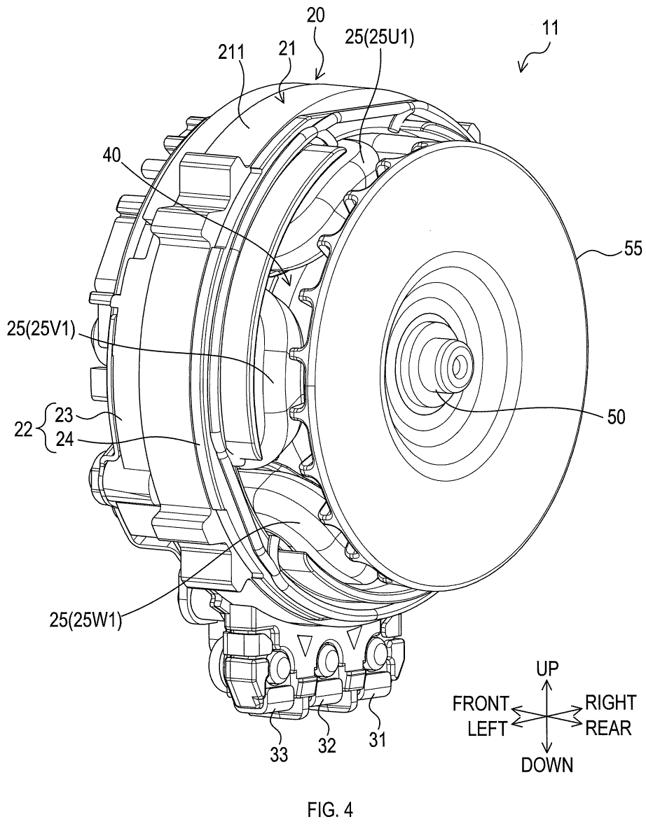

As shown in FIG. 2 to FIG. 6, the motor 11 comprises a stator 20 and a rotor 40. The motor 11 according to the present embodiment is in the form of an inner-rotor-type motor.

The motor 11 according to the present embodiment is in the form of a three-phase brushless motor, which comprises 4m (where m is a natural number) magnetic poles and 3m slots. As one example of a combination of such a pole count (i.e., the number of magnetic poles) and slot count, the present embodiment is an illustrative example of an 8-pole/6-slot brushless motor.

The stator 20 has a substantially circular-ring shape overall. The rotor 40 is rotatably disposed in the interior of the stator 20.

Here, the terms “axial direction,” the “radial direction,” and the “circumferential direction” are defined as follows. The axial direction is a direction parallel to rotational axis AX of the motor 11 and is oriented forward. The radial direction is a direction extending from rotational axis AX perpendicular to rotational axis AX. The circumferential direction is a direction that goes around rotational axis AX, for example, clockwise.

### 2-1-2a. Stator

The stator 20 comprises a stator core 21. The stator core 21 is formed of electromagnetic steel, which is also known as electrical steel. The stator core 21 comprises a plurality of electromagnetic-steel sheets (electrical steel sheets) that are laminated together in the axial direction. Stated more generally, the material forming the stator core 21 is preferably magnetically permeable; more specifically, the stator core 21 is preferably made of a magnetically permeable, iron alloy.

The stator core 21 comprises a back core 211. The back core 211 has a tube shape. The central longitudinal axis of the back core 211 coincides with rotational axis AX.

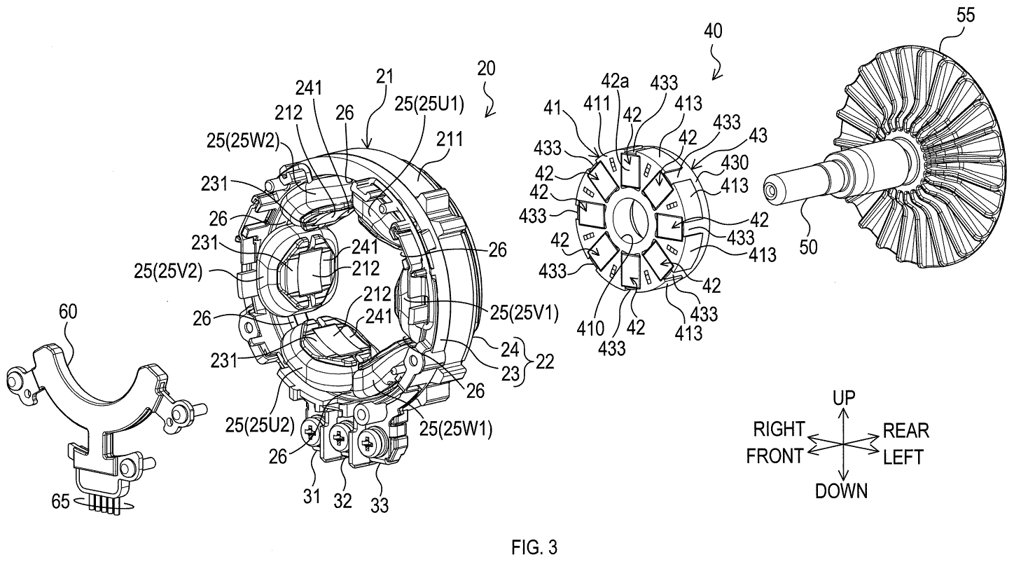

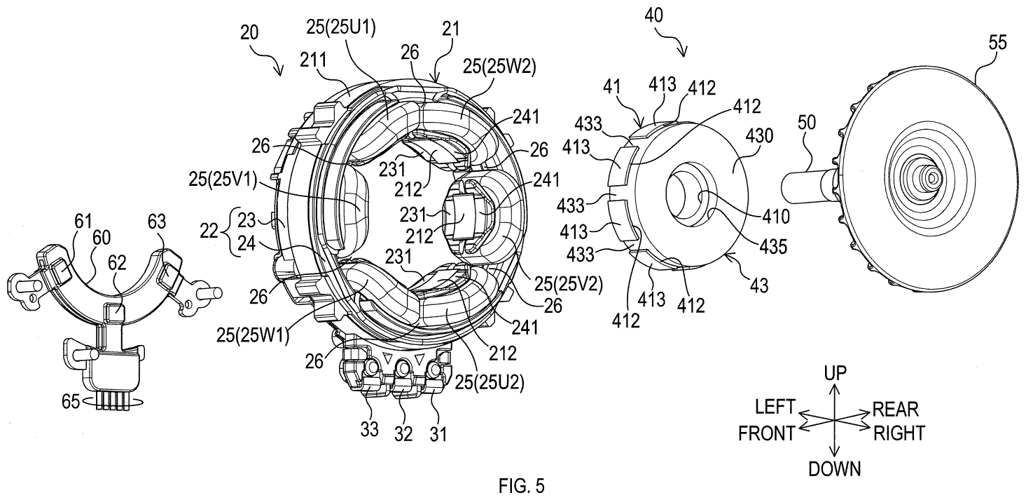

As shown in FIG. 3 and FIG. 5, the stator core 21 comprises a plurality of core teeth 212. The core teeth 212 protrude from an inner-circumferential surface of the back core 211 in the reverse direction of the above-defined radial direction (i.e., the core teeth 212 extend radially inward toward rotational axis AX). The core teeth 212 are disposed (arranged) equispaced in the circumferential direction. The core teeth 212 are integrally formed with the back core 211. In the present embodiment, six of the core teeth 212 are provided.

As shown in FIG. 2 to FIG. 6, the stator 20 comprises insulators 22. Though merely one example, in greater detail, the insulators 22 according to the present embodiment include a first insulator 23 and a second insulator 24. The first and second insulators 23, 24 each have a substantially circular-ring shape or a substantially tubular shape. The first and second insulators 23, 24 are each electrically insulating members and, for example, are made of a polymer (synthetic resin).

The first insulator 23 is fixed to the stator core 21 at a forward side of the stator core 21 and covers a surface on the forward side of the stator core 21. The second insulator 24 is fixed to the stator core 21 at a rearward side of the stator core 21 and covers a surface on the rearward side of the stator core 21. The first and second insulators 23, 24 may be integrally molded with the stator core 21, e.g., in an insert molding process.

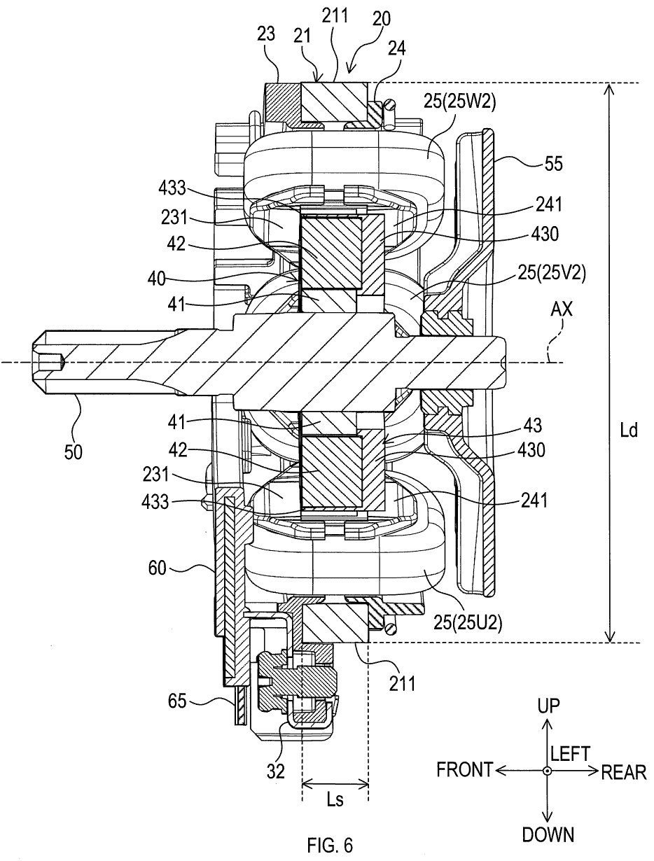

As shown in FIG. 3, FIG. 5, and FIG. 6, the first insulator 23 comprises a plurality of first teeth 231. The first teeth 231 protrude from an inner-circumferential surface of a circular-ring-shaped (or tube-shaped) member of the first insulator 23 in a reverse direction of the above-defined radial direction (i.e., the first teeth 231 extend radially inward toward rotational axis AX). In the present embodiment, six of the first teeth 231 are provided. Each of the first teeth 231 covers a forward-side surface of one corresponding core tooth 212 from among the plurality of core teeth 212.

The second insulator 24 comprises a plurality of second teeth 241. The second teeth 241 protrude from an inner-circumferential surface of a circular-ring-shaped (or tube-shaped) member of the second insulator 24 in a reverse direction of the above-defined radial direction (i.e., the second teeth 241 extend radially inward toward rotational axis AX). In the present embodiment, six of the second teeth 241 are provided. Each of the second teeth 241 covers a rearward-side surface of one corresponding core tooth 212 from among the plurality of core teeth 212.

Each one of the stator teeth is formed by one core tooth 212 from among the plurality of core teeth 212, one first tooth 231 from among the plurality of first teeth 231 that corresponds to that core tooth 212, and one second tooth 241 from among the plurality of second teeth 241 that corresponds to that core tooth 212. That is, in the present embodiment, the stator 20 comprises six stator teeth.

The stator 20 comprises 3m (where m is a natural number) slots 26. The stator according to the present embodiment comprises, as one example, six stator teeth. Consequently, the stator 20 according to the present embodiment includes six of the slots 26. That is, in the present embodiment, m=2. Each of the six slots 26 corresponds to a space between two circumferentially adjacent stator teeth.

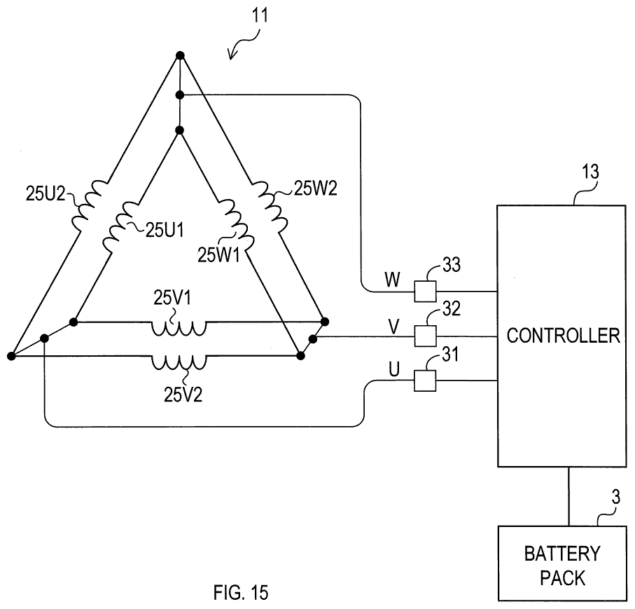

As shown in FIG. 2 to FIG. 6, the stator 20 comprises a plurality of coils 25. In the present embodiment, six of the coils 25 are provided. For each of the six coils 25, one corresponding stator tooth among the six stator teeth is provided. That is, in the state in which the six coils 25 are respectively wound around the six stator teeth, each of the six coils 25 is provided in a prescribed space that includes the two slots 26 on both end sides of that stator tooth. The motor-drive electric power (drive currents) described above is supplied to the six coils 25. As will be described below with reference to FIG. 15, the six coils 25 are electrically connected to each other by a prescribed connection method.

### 2-1-2b. Rotor

As shown in FIG. 2, FIG. 3, FIG. 5, and FIG. 6, the rotor 40 comprises a rotor core 41 and a plurality of permanent magnets 42.

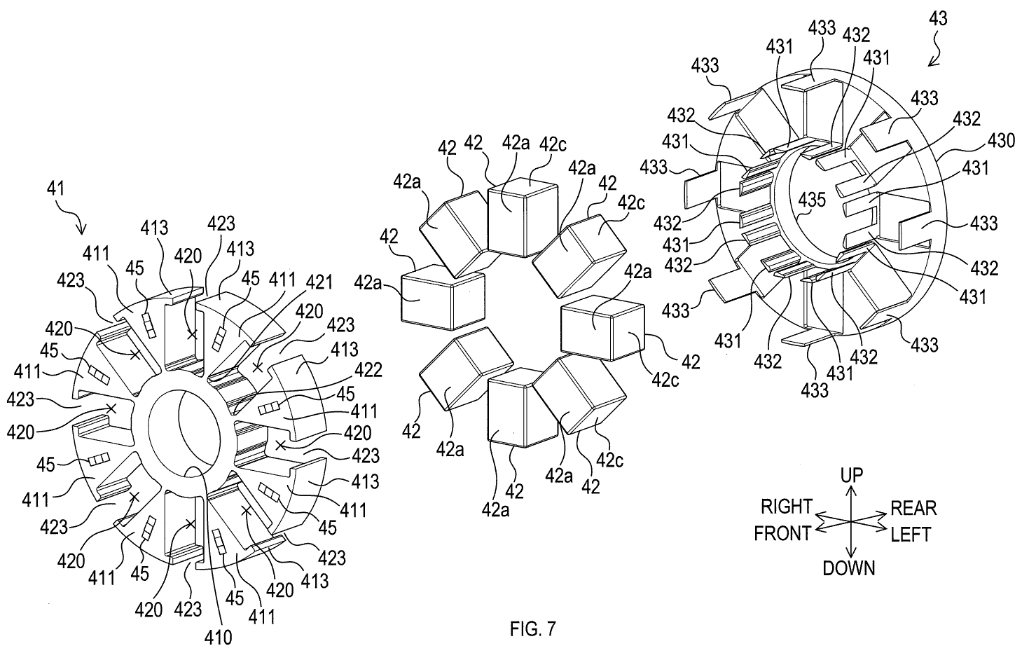

As shown in FIG. 3 and FIG. 5, the rotor core 41 has a center hole 410, which passes through in the axial direction. A rotor shaft 50 is inserted through the center hole 410 and fixed therein. The rotor core 41 has an outer-circumferential surface 413. The outer-circumferential surface 413 is notched (has cutouts or gaps) at equal intervals in the circumferential direction. The plurality of these notched locations corresponds to a plurality of openings 423 and a plurality of holes 420 (see FIG. 7), which will be further described below.

The permanent magnets 42 are disposed at least partially in the interior of the rotor core 41. In the explanation below, when referring to simply “the permanent magnet 42,” it means each one or an arbitrary one of the plurality of permanent magnets 42. Similarly, when referring to simply “the opening 423,” it means each one or an arbitrary one of the plurality of openings 423; and when referring to simply “the hole 420,” it means each one or an arbitrary one of the plurality of holes 420.

The permanent magnets 42 are preferably formed as sintered magnets in the present embodiment, although other types of magnets may be used with the present teachings. The permanent magnets 42 are disposed mutually equispaced in the circumferential direction of the rotor core 41. The permanent magnets 42 are respectively disposed in the above-described plurality of notched locations of (in) the outer-circumferential surface 413 of the rotor core 41.

As shown in FIG. 3, FIG. 5, and FIG. 6, the rotor 40 comprises a resin part 43. The resin part 43 fixes the plurality of permanent magnets 42 to be integral with the rotor core 41. In the present embodiment, the rotor core 41 and the plurality of permanent magnets 42 are integrally molded with each other by the resin part 43. Herein, the term “resin part 43” is understood to be a solid polymer piece (structure).

The resin part 43 comprises an end-surface fixing part 430. The end-surface fixing part 430 covers the stator core 21 and the plurality of permanent magnets 42 from the rearward sides thereof. As shown in FIG. 5 and FIG. 6, in the present embodiment, the end-surface fixing part 430 covers the permanent magnets 42 from the rearward sides thereof. That is, the portions of the permanent magnets 42 that protrude beyond the rotor core 41 from end surfaces (i.e., second end surfaces 412 described below) on the rearward side of the rotor core 41 are at least partially (in the present embodiment, completely) covered by the end-surface fixing part 430.

In addition, as shown in FIG. 5, the end-surface fixing part 430 covers nearly all of each of the second end surfaces 412 of the rotor core 41.

In contrast, as shown in FIG. 3, end surfaces (i.e. first end surfaces 411 described below) on the forward side of the rotor core 41 and surfaces on the forward side of the permanent magnets 42 are not covered by the resin part 43 and are thus exposed towards the front.

As shown in FIG. 5, the end-surface fixing part 430 has a center hole 435. The central axis of the center hole 435 coincides with rotational axis AX. Though merely one example, the inner diameter of the center hole 435 of the end-surface fixing part 430 is larger than the inner diameter of the center hole 410 of the rotor core 41.

As shown in FIG. 3, FIG. 5, and FIG. 6, the resin part 43 comprises a plurality of outer-circumference fixing parts 433. Although the reference numerals are omitted from FIG. 2 to FIG. 6, the resin part 43 comprises a plurality of first fixing parts 431 (see FIG. 7). Although the reference numerals are omitted from FIG. 2 to FIG. 6, the resin part 43 also comprises a plurality of second fixing parts 432 (see FIG. 7). The outer-circumference fixing parts 433 respectively cover the notched locations (i.e. the openings 423), which were described above, of (in) the outer-circumferential surface 413 of the rotor core 41.

As shown in FIG. 2 to FIG. 6, the motor 11 comprises the rotor shaft 50 described above. The rotor shaft 50 is fixed to (in) the rotor core 41 (and in turn to the rotor 40) in the state in which the rotor shaft 50 has been inserted through the center hole 410 of the rotor core 41. The rotor shaft 50 may be, for example, press-fitted into the rotor core 41 and thereby fixed to the rotor core 41. The central axis of the rotor shaft 50 coincides with rotational axis AX. Accordingly, the rotor 40 and the rotor shaft 50 rotate about rotational axis AX.

### 2-1-2c. Sensor Board

As shown in FIG. 2, FIG. 3, FIG. 5, and FIG. 6, the motor 11 comprises a sensor board 60. As shown in FIG. 5, the sensor board 60 comprises three magnetic sensors 61, 62, 63. The three magnetic sensors 61, 62, 63 each output a position signal in accordance with the rotational position of the rotor 40.

As shown in FIG. 2, FIG. 3, FIG. 5, and FIG. 6, the motor 11 comprises a lead group 65, which is electrically connected to the sensor board 60. The lead group 65 according to the present embodiment comprises five lead lines (wires). The lead group 65 is electrically connected to the controller 13.

The controller 13 supplies power-supply power to the three magnetic sensors 61, 62, 63 via the lead group 65. The three magnetic sensors 61, 62, 63 receive power-supply power to operate. The position signal output by each of the three magnetic sensors 61, 62, 63 is input into the controller 13 via the lead group 65.

### 2-1-2d. Electric Power Terminals

As shown in FIG. 3 to FIG. 6, the motor 11 comprises a first electric power terminal 31, a second electric power terminal 32, and a third electric power terminal 33. The first to third electric power terminals 31-33 are electrically connected to the six coils 25. The first to third electric power terminals 31-33 are electrically connected to the controller 13 and receive the above-described motor-drive electric power (drive currents) from the controller 13. Motor-drive electric power is supplied to the stator 20 (in more detail, to the six coils 25) via the first to third electric power terminals 31-33.

### 2-1-2e. Electrical Configuration of the Electric Work Machine

A summary of the electrical configuration of the electric work machine 1 is explained principally referencing FIG. 15 and on the basis of FIG. 1 to FIG. 6.

The controller 13 receives battery power from the battery pack 3. The controller 13 comprises, for example, all of: the control circuit, a power-supply circuit, and the drive circuit, which are not shown.

The drive circuit receives battery power. The drive circuit is formed as, for example, a three-phase, full-bridge circuit. That is, the drive circuit comprises six semiconductor switching elements (e.g., power FETs). Each of the six semiconductor switching elements is individually controlled by control instructions from the control circuit. The drive circuit converts battery power into the above-described motor-drive electric power (i.e., three-phase electric power (currents)) in accordance with the control instructions from the control circuit and supplies such to the motor 11. Thereby, motor-drive electric power is input to the first to third electric power terminals 31-33 of the motor 11, and the motor 11 is driven.

The control circuit comprises a microcomputer, e.g., one or more microprocessors, memory/storage, input-output devices, etc. The control circuit is configured to execute various programs stored therein. Various functions of the electric work machine 1 are realized by the control circuit executing the various programs. The functions realized by the control circuit include functions for controlling the drive circuit.

In addition, the three position signals from the sensor board 60 are input to the control circuit. The control circuit detects the rotational position (i.e. the electrical angle) of the rotor 40 based on these three position signals. The control circuit generates the control instructions on the basis of the rotational positions detected and other drive information and outputs the control instructions to the drive circuit. Thereby, appropriate motor-drive electric power is (drive currents are) supplied to the motor 11 in accordance with the rotational position of the rotor 40, the drive information and the selected action mode (and the selected torque upper limit, if set). The drive information includes, for example, the amount of manipulation (pulling) of the trigger 8.

The control circuit according to the present embodiment is configured so that the motor 11 is caused to rotate at an electric frequency of 1,333 Hz or more. The electric frequency is an integrated value resulting from integrating the rotational speed of the rotor 40 per unit of time and the pole-pairs count. In the present embodiment, specifically, it is the integrated value resulting from integrating the rotational speed of the rotor 40 per second and the pole-pairs count. The pole-pairs count is ½ of the pole count.

In the present embodiment, the pole-pairs count is four because the pole count of the motor 11 is eight. Consequently, in the present embodiment, causing the motor 11 to rotate at an electric frequency of 1,333 Hz or more means the same as causing the motor 11 to rotate at a rotational speed of 20,000 rpm or more.

In the present embodiment, for example, the rated electric frequency of the motor 11 may be set to 1,333 Hz or more. Alternatively, the electric frequency when the motor 11 is rotated at the maximum rotational speed when the electric work machine 1 is being used may be 1,333 Hz or more. In other words, the rated rotational speed of the motor 11 may be set to 20,000 rpm or more, or the maximum rotational speed when using the electric work machine 1 may be 20,000 rpm or more. The control circuit may be configured, for example, to control the motor 11 (and directly, the drive circuit) such that the motor 11 always—or while the amount of manipulation of the trigger 8 is a prescribed amount or more in response to manipulation of the trigger 8—rotates at the electric frequency of 1,333 Hz or more.

The six coils 25 of the motor 11 can be partitioned into a first-phase coil group, a second-phase coil group, and a third-phase coil group. As shown in FIG. 15 (and in FIG. 3 and FIG. 5), the first-phase coil group includes a pair of first-phase coils 25U1, 25U2, which are mutually connected in parallel. The second-phase coil group includes a pair of second-phase coils 25V1, 25V2, which are mutually connected in parallel. The third-phase coil group includes a pair of third-phase coils 25W1, 25W2, which are mutually connected in parallel. Furthermore, the first-phase coil group, the second-phase coil group, and the third-phase coil group are delta-connected to each other.

Changing viewpoints, the motor 11 can be said to comprise two delta-connection groups. The first delta-connection group comprises the first-phase coil 25U1, the second-phase coil 25V1, and the third-phase coil 25W1, which are delta-connected to each other. The second delta-connection group comprises the first-phase coil 25U2, the second-phase coil 25V2, and the third-phase coil 25W2, which are delta-connected to each other. The first and second delta-connection groups are mutually connected in parallel.

Furthermore, a first end of each of the first-phase coils 25U1, 25U2 and a second end of each of the second-phase coils 25V1, 25V2 are connected to the first electric power terminal 31. A first end of each of the second-phase coils 25V1, 25V2 and a second end of each of the third-phase coils 25W1, 25W2 are connected to the second electric power terminal 32. A first end of each of the third-phase coils 25W1, 25W2 and a second end of each of the first-phase coils 25U1, 25U2 are connected to the third electric power terminal 33.

It is noted that the coils 25 (six coils in the present embodiment) in the motor 11 may be wired in any manner. For example, the pair of first-phase coils 25U1, 25U2 in the first-phase coil group may be mutually connected in series. The same applies to the second-phase coil group and the third-phase coil group.

In addition, the first-phase coil 25U1, the second-phase coil 25V1, and the third-phase coil 25W1 may be, for example, star-connected. The same applies to the other coils, i.e., the first-phase coil 25U2, the second-phase coil 25V2, and the third-phase coil 25W2.

### 2-1-2f. Fan

As shown in FIG. 2 to FIG. 6, the motor 11 comprises a fan 55. The fan 55 is fixed to the rearward end portion of the rotor shaft 50. The fan 55 rotates together with the rotor 40 and thereby generates a draft. That draft cools the motor 11.

### 2-1-3. Detailed Configuration of the Rotor

The configuration of the exemplary rotor 40 will now be explained in greater detail with reference to FIG. 7 to FIG. 14.

As described above, the rotor 40 comprises the rotor core 41, the plurality of permanent magnets 42, and the resin part 43.

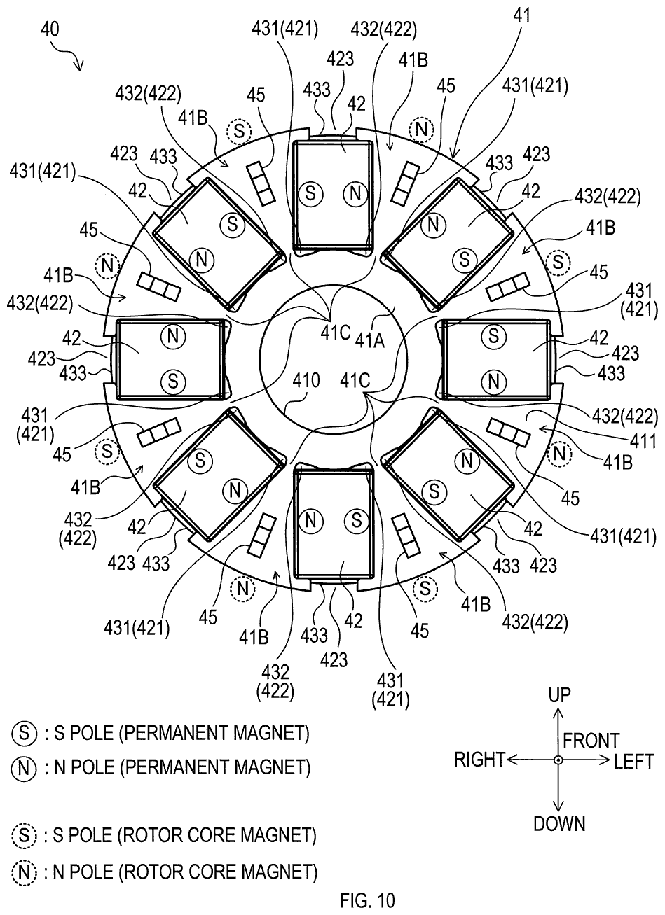

In the present embodiment, the rotor 40 is configured to have 4m magnetic poles along (around) the outer circumference. As described above, in the present embodiment, m=2. Consequently, the rotor 40 according to the present embodiment has eight magnetic poles along (around) the outer circumference, as shown in FIG. 10.

To provide the rotor 40 with eight magnetic poles in the present embodiment, 4m permanent magnets 42, that is, eight permanent magnets 42, are mounted in the rotor core 41.

The resin part 43 is composed of a polymer (i.e. a cured and/or solidified resin). The resin part 43 may include one or more materials other than the polymer (resin), such as e.g., one or more of a filler (e.g., glass fibers), a plasticizer, a stabilizer (e.g., a heat stabilizer), an antioxidant, a crosslinking agent, a flame retardant, etc. In the present embodiment, the resin part 43 is preferably composed entirely, or at least substantially, of a polymer (resin). The resin part 43 according to the present teachings may include a thermosetting polymer (resin). In the present embodiment, the resin part 43 is preferably composed entirely, or at least substantially, of a thermosetting polymer (resin). Examples of thermosetting resins suitable for forming the resin part 43 include, but are not limited to, unsaturated polyester, phenol resin, urea resin, melamine resin, and/or epoxy resin.

Each of the permanent magnets 42 preferably has a substantially rectangular parallelepiped shape. A longest dimension of the permanent magnets 42 extends along the radial direction (i.e. perpendicular to the rotational axis). That is, in the present embodiment, the permanent magnets 42 are disposed (arranged) in a spoked (in other words, in a radial) shape. Stated more generally, the permanent magnets 42 each preferably have an oblong shape (e.g., an oblong polyhedron shape) and the longest dimension of the oblong shape extends in the radial direction (i.e. perpendicular to the rotational axis).

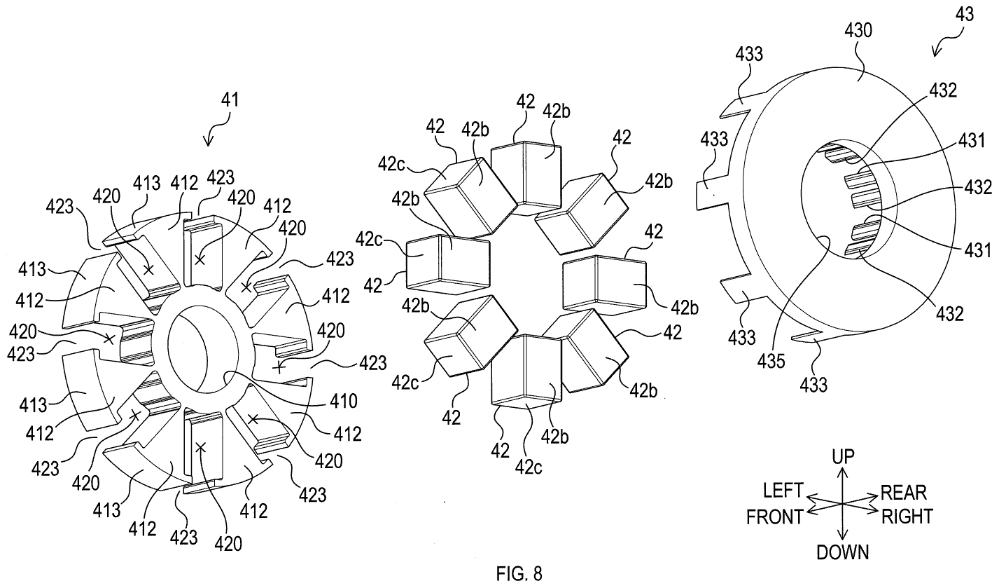

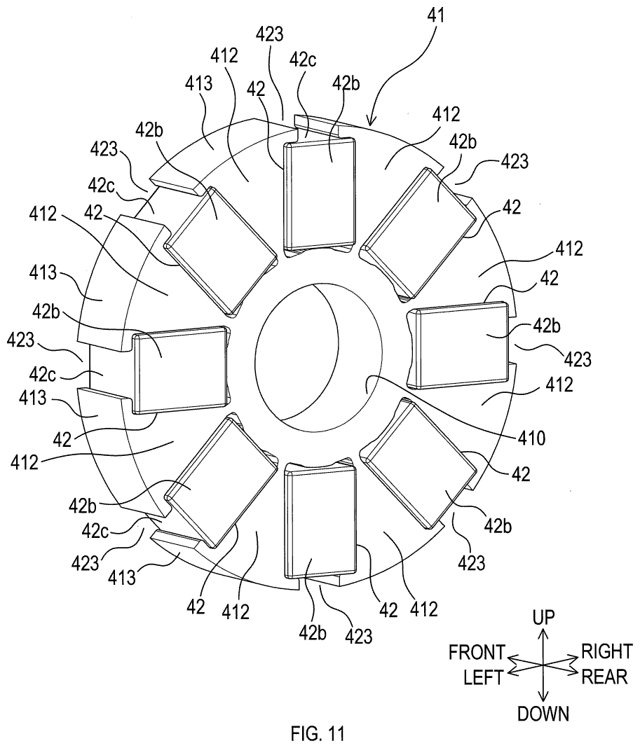

As shown in FIG. 7, FIG. 8, and FIG. 11, each of the permanent magnets 42 has a first surface 42a and a second surface 42b, which extend in respective (preferably parallel) planes that intersect (in the present embodiment, are orthogonal to) the axial direction, and a third surface 42c. The first surface 42a is the surface that faces forward, the second surface 42b is the surface that faces rearward, and the third surface 42c is the surface that faces in the radial direction (i.e. the third surface 42c is radially outward facing).

Furthermore, as shown in FIG. 10, the permanent magnets 42 are disposed such that like poles oppose each other in the circumferential direction. It is noted that, in FIG. 10, the letter “S” enclosed by a solid line circle indicates that this region is an S pole, and the letter “N” enclosed by a solid line circle indicates that this region is an N pole. The N pole and the S pole of each of the permanent magnets 42 are side-by-side in the circumferential direction, as can be seen in FIG. 10.

Accordingly, N magnetic poles and S magnetic poles are alternately produced (present) in the circumferential direction at the outer-circumferential surface 413 of the rotor core 41. For example, an N pole is induced at (along) the portion of the outer-circumferential surface 413 of a magnet-support part 41b that is located between (that holds or supports) two of the permanent magnets 42 having N poles opposing each other in the circumferential direction. It is noted that, in FIG. 10, the letter “S” enclosed in a broken line circle indicates an S magnetic pole formed by two circumferentially-adjacent S magnetic poles of two circumferentially-adjacent permanent magnets 42, and the letter “N” enclosed in a broken line circle indicates an N magnetic pole formed by two circumferentially-adjacent N magnetic poles of two circumferentially-adjacent permanent magnets 42. The rotor 40 according to the present embodiment has four N magnetic poles and four S magnetic poles, and thus in total has eight magnetic poles as described above.

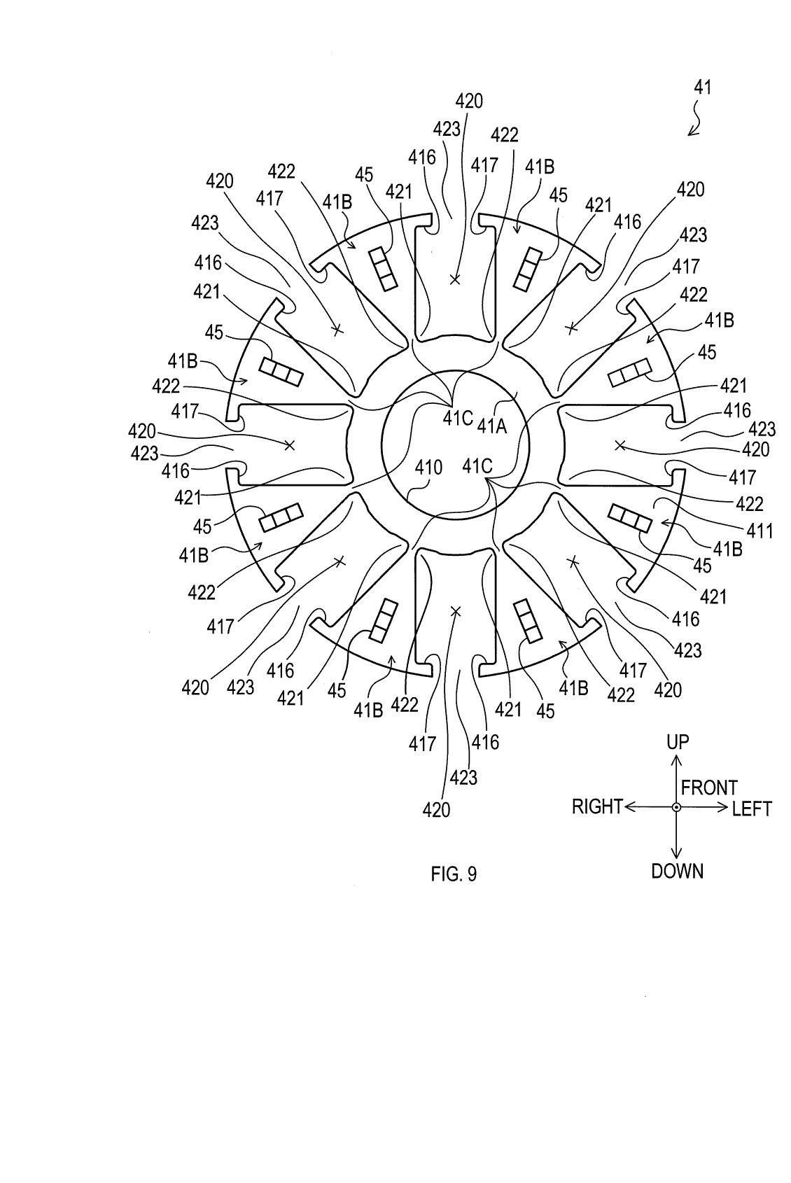

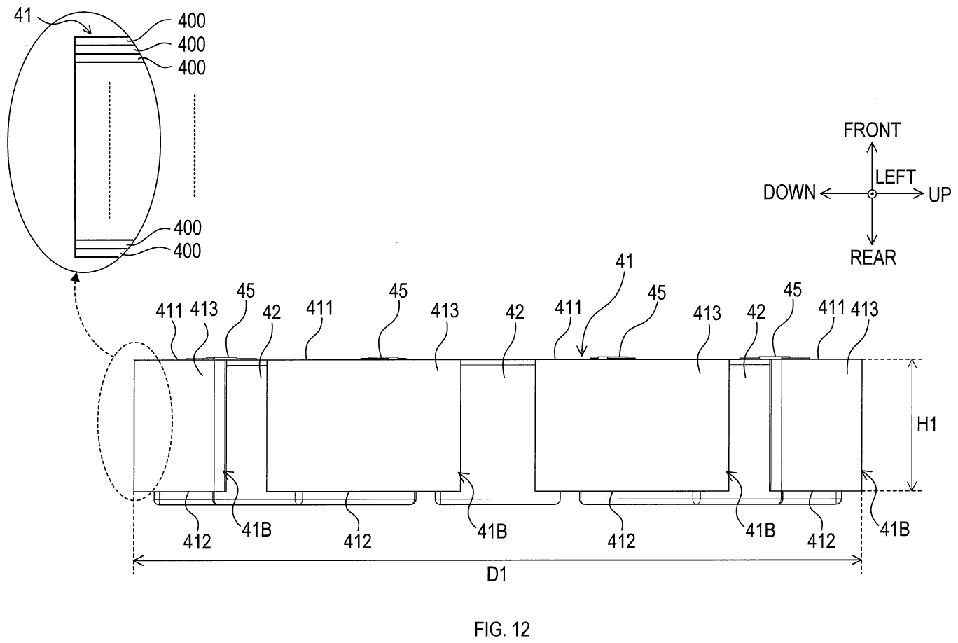

As shown in FIG. 7 to FIG. 11, the rotor core 41 has the center hole 410 as described above. As shown in FIG. 7, FIG. 8, FIG. 11, and FIG. 12, the rotor core 41 has the first end surfaces 411, the second end surfaces 412, and the outer-circumferential surface 413 described above. It is noted that, in FIG. 9 and likewise in FIG. 10, although the reference numerals are omitted, the first end surfaces 411 are shown. Of the two end surfaces of the rotor core 41 that intersect (in the present embodiment, are orthogonal to) the axial direction, the first end surfaces 411 correspond to the forward-side end surfaces. Of the above-mentioned two end surfaces of the rotor core 41, the second end surfaces 412 correspond to the rearward-side end surfaces.

As shown in FIG. 7 to FIG. 9, the rotor core 41 has the plurality of holes 420. The holes 420 are disposed mutually spaced apart (in the present embodiment, equispaced) in the circumferential direction. Eight of the holes 420 are provided in the present embodiment. The eight permanent magnets 42 are respectively inserted into the eight holes 420.

FIG. 10 to FIG. 12 and above-described FIG. 2 to FIG. 6 show the state in which the permanent magnets 42 have been respectively inserted into the holes 420. In the present embodiment, at least one portion (in the present embodiment, the entirety) of the first surface 42a of each of the permanent magnets 42 and at least one portion (in the present embodiment, the entirety) of each of the first end surfaces 411 of the rotor core 41 are coplanar, as can be seen in FIGS. 2 and 3. In contrast, as shown in FIG. 11 and FIG. 12, the second surfaces 42b of the permanent magnets 42 protrude more rearward than the second end surfaces 412 of the rotor core 41.

As shown in FIG. 7 to FIG. 11 and FIG. 14, the rotor core 41 has the openings 423. The openings 423 are disposed mutually spaced apart in the circumferential direction at (in) the outer-circumferential surface 413 of the rotor core 41. That is, as described above, the outer-circumferential surface 413 of the rotor core 41 is notched (cutout) at a prescribed spacing in the circumferential direction, and those notched (cutout) portions (gaps) correspond to the openings 423.

The openings 423 respectively connects to the holes 420. Accordingly, each of the holes 420 is exposed in the radial direction (i.e. radially outward) via (through) its associated opening 423.

Consequently, if each of the openings 423 were not closed up (hypothetically speaking), then each of the permanent magnets 42 respectively inserted into (disposed) the holes 420 would be exposed in the radial direction (i.e. radially outward) via (through) that opening 423. However, in the present embodiment, as described above with reference to FIG. 3 and FIG. 5, and as shown in FIG. 10, the openings 423 are closed up (covered) by the resin part 43 (in more detail, by the plurality of outer-circumference fixing parts 433).

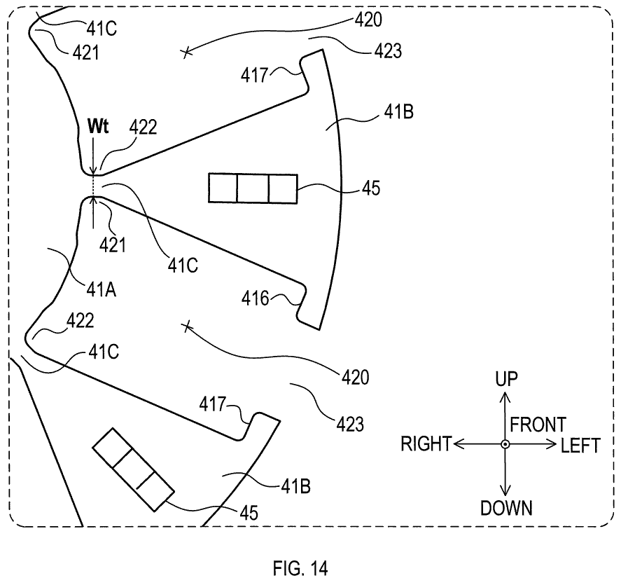

As shown in FIG. 7, FIG. 9, FIG. 10, and FIG. 14, each of the holes 420 has at least one runner. The at least one runner is filled with liquid resin (polymer), e.g., melted resin or polymer, during the process of forming the resin part 43, and the liquid resin (polymer) is allowed to solidify (e.g., by cooling and/or curing). In the present embodiment, each of the holes 420 has a first runner 421 and a second runner 422. The first runners 421 and the second runners 422 are respectively spaces that are formed between inner-circumferential surfaces of one hole 420 and one permanent magnet 42 inserted into that hole 420 and that pass through in (extend along) the axial direction.

In addition, each of the openings 423 likewise functions as a runner. That is, during the process of forming the resin part 43, each of the openings 423 is also filled with resin or polymer, and thereby each of the openings 423 is closed up as described above.

In each of the holes 420, at least the first runner 421, the second runner 422, and the opening 423 is filled with liquid (optionally, melted) resin or polymer, which is then cured or cooled/solidified, and thereby that resin (polymer) is in close contact with and securely bonds the inner-circumferential surfaces of the hole 420 with the corresponding permanent magnet 42. Thereby, each of the permanent magnets 42 is bonded to the inner-circumferential surfaces of the corresponding hole 420 via (by) the resin or polymer. In addition, the side surfaces of each of the permanent magnets 42, which oppose the inner-circumferential surfaces of the corresponding hole 420, are nearly completely in contact with the inner-circumferential surfaces of the hole 420 and receive pressure from those inner-circumferential surfaces. Consequently, even if there were no resin part 43, each of the permanent magnets 42 would be fixed to the corresponding hole 420 by the pressure received from the hole 420 and/or the contact friction between itself and the inner-circumferential surfaces of the hole 420. Consequently, each of the permanent magnets 42 is fixed more rigidly to, and integrally with, the corresponding hole 420 by the resin part 43, and in turn is fixed rigidly to and integrally with the rotor core 41.

As shown together with reference numerals in FIG. 9 and FIG. 14, the rotor core 41 comprises a plurality of first restricting parts (first flanges or ribs) 416 and a plurality of second restricting parts (second flanges or ribs) 417. Each of the first restricting parts 416 forms one pair with one corresponding second restricting part 417 among the plurality of second restricting parts 417. Thus, each of the openings 423 is defined (formed) by a pair of one of the first restricting parts 416 that is circumferentially adjacent to one of the second restricting parts 417.

In particular, as is clear from FIG. 9 and FIG. 10, each pair constituted by one of the first restricting parts 416 and one of the second restricting parts 417 opposes (faces) one of the permanent magnets 42, which is inserted into the corresponding hole 420, along (in) the radial direction. Thereby, movement of the permanent magnet 42 from (out of) the hole 420 in the radial direction (and in turn, its detachment from the rotor core 41) is restricted (blocked). That is, the first and second restricting parts 416, 417 block (prevent) the permanent magnets 42 from escaping from (moving radially outward through) the holes 420.

As is shown in a partial exploded view in FIG. 12, the rotor core 41 is constituted by laminating a plurality of core sheets 400 in the axial direction. Each of the core sheets 400 has a sheet shape. The core sheets 400 comprise or are composed of a soft magnetic material, i.e. a material (preferably, a magnetically permeable iron alloy) having a low coercivity. The core sheets 400 of the present embodiment are preferably electromagnetic steel sheets that comprise (or are composed of) electromagnetic steel, i.e. electrical steel.

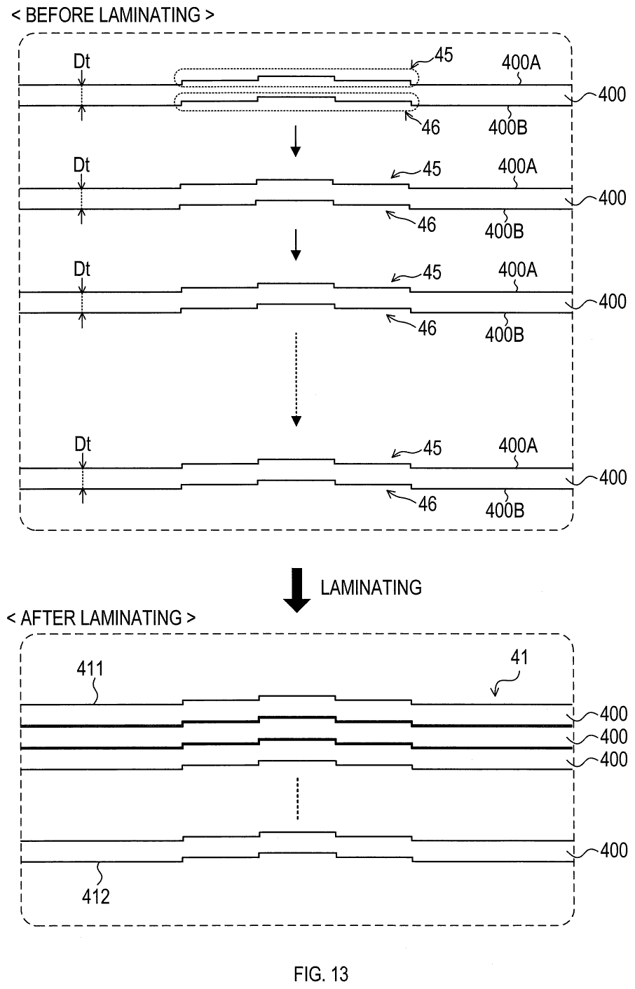

As shown in FIG. 13, each of the core sheets 400 has a first surface 400A and a second surface 400B.

In the present embodiment, thickness Dt of each of the core sheets 400 is greater than 0 mm and is 0.35 mm or less, i.e. 0 mm<Dt≤0.35 mm. It is noted that thickness Dt is the length (depth) of each of the core sheets 400 in the axial direction.

Thickness Dt may be any value within the range of greater than 0 mm and 0.35 mm or less. Thickness Dt may be, for example, greater than 0.30 mm and 0.35 mm or less. Alternatively, thickness Dt may be, for example, greater than 0.25 mm and 0.30 mm or less. Alternatively, thickness Dt may be, for example, 0.25 mm or less. Specifically, thickness Dt may be, for example, greater than 0.23 mm and 0.25 mm or less. Alternatively, thickness Dt may be, for example, greater than 0.20 mm and 0.23 mm or less. Alternatively, thickness Dt may be, for example, 0.20 mm or less. Thickness Dt may be, for example, 0.05 mm or more. Alternatively, thickness Dt may be, for example, 0.10 mm or more.

Protruding portions 45 are respectively formed on the first surfaces 400A. Recessed portions 46 are respectively formed on the second surfaces 400B. The protruding portions 45 are also shown in FIG. 7, FIG. 9, FIG. 10, FIG. 12, and FIG. 14. Depiction of the recessed portions 46 is omitted in FIG. 8 and FIG. 11.

The recessed portions 46 are respectively provided on the second surfaces 400B at a location or locations at which they overlap with the protruding portions 45 in the axial direction.

During the process of laminating the core sheets 400, the protruding portion 45 of one of the two axially-opposing core sheets 400 is inserted into the corresponding recessed portion 46 of the other of the two axially-opposing core sheets 400. Thereby, as shown in FIG. 13, the rotor core 41 (i.e., a lamination) is formed in which the core sheets 400 are laminated to each other in mutually close contact in the axial direction.

When the protruding portions 45 are respectively inserted into the recessed portions 46, the protruding portions 45 can no longer detach (or tend not to detach) from the recessed portions 46 owing to the pressure (and/or the frictional force) acting reciprocally between the protruding portions 45 and the recessed portions 46.

In the present embodiment, when the protruding portions 45 are inserted into the recessed portions 46, the protruding portions 45 and/or the recessed portions 46 are subject to mechanical deformation (elastic deformation and/or plastic deformation) owing to the pressure received at the time of insertion. The protruding portions 45 are thereby clinched to (and securely retained in) the recessed portions 46 owing to that mechanical deformation.

As shown in FIG. 9, FIG. 10, FIG. 12, and FIG. 14 together with reference numerals, the rotor core 41 can be, in principle, partitioned into three regions, namely: a core ring 41A; a plurality of magnet-support parts 41B; and a plurality of connecting portions 41C.

The core ring 41A is a circular-tube-shaped region at the central portion of the rotor core 41.

The magnet-support parts 41B are disposed radially outward of the core ring 41A, equispaced apart in the circumferential direction. The rotor core 41 according to the present embodiment comprises eight of the magnet-support parts 41B. The spaces between each pair of two circumferentially-adjacent magnet-support parts 41B respectively correspond to (define) the plurality of holes 420.

Each of the connecting portions 41C couples the associated (attached) magnet-support part 41B to the core ring 41A. That is, the rotor core 41 according to the present embodiment comprises eight of the connecting portions 41C. Minimum width Wt, which is shown in FIG. 14, is the width at the portion of each of the connecting portions 41C where the width is the smallest. The width is a length in a direction perpendicular to both the axial direction and the radial direction. In other words, the width of the smallest portion of the connecting portions extends perpendicular to the rotational axis of the rotor and to the radial direction of the rotor.

In the present embodiment, minimum width Wt is preferably in the range of 0.4-0.6 mm. The smaller the minimum width Wt is, the larger the reluctance of each of the connecting portions 41C is, and the smaller the magnetic flux that short circuits those connecting portions 41C becomes. The smaller the magnetic fluxes that short circuit the connecting portions 41C are, the more effectively the magnetic fluxes of the permanent magnets 42 can be utilized to drive the rotation the motor 11. Consequently, to achieve the goal of reducing the magnetic fluxes that short circuit the connecting portions 41C, the smaller the minimum width Wt is, the better.

On the other hand, the smaller the minimum width Wt is, the weaker the structural connection force (strength) for connecting the magnet-support parts 41B to the core ring 41A becomes. Therefore, to achieve the goal of securely (robustly) fixing the magnet-support parts 41B to the core ring 41A to thereby securely (robustly) fix the permanent magnets 42 to the rotor core 41, the larger the minimum width Wt is, the better.

Thus, there is a tradeoff between (a) reducing magnetic-flux short circuits on the one hand and (b) securely (robustly) fixing the magnet-support parts 41B to the core ring 41A on the other hand. Accordingly, in the present embodiment, both reducing magnetic-flux short circuits and securely fixing the magnet-support parts 41B can be achieved by setting minimum width Wt to a width within the range of 0.4-0.6 mm.

Each of the core sheets 400 corresponds to (has) (i) one portion of the core ring 41A, (ii) one portion of each of the magnet-support parts 41B, and (iii) one portion of each of the connecting portions 41C. Thus, the core ring 41A, the plurality of magnet-support parts 41B, and the plurality of connecting portions 41C are formed by laminating the plurality of core sheets 400 together.

As shown in FIG. 7, FIG. 8, and FIG. 10, the resin part 43 comprises the above-mentioned end-surface fixing part 430, the above-mentioned first fixing parts 431, the above-mentioned second fixing parts 432, and the above-mentioned outer-circumference fixing parts 433. The first fixing parts 431 are formed by curing or solidifying the resin or polymer that filled the first runners 421. The second fixing parts 432 are formed by curing or solidifying the resin or polymer that filled the second runners 422. The outer-circumference fixing parts 433 are formed by curing the resin that filled the openings 423.

The rotor 40 may be integrally formed (integrated) in any manner. The rotor may be integrally molded by, for example, insert molding. More specifically, the rotor 40 may be integrally molded by, for example, the methods described below. That is, first, the rotor core 41 and the permanent magnets 42 are disposed in a mold. At this time, the plurality of permanent magnets 42 are respectively inserted into the plurality of holes 420 in the rotor core 41. In addition, the above-described runners are present in each of the holes 420.

Next, liquid (optionally molten) resin (or polymer) is injected into the mold. Thereby, each resin-filling space in the interior of the mold, which includes the above-mentioned plurality of runners, is filled with resin (or polymer).

Then, the filled resin or polymer is cured or cooled/solidified, and thereafter, the integrated (i.e. one-piece) rotor 40 is removed from the mold.

Thereby, the rotor 40 is obtained in which the rotor core 41 and the plurality of permanent magnets 42 are integrated (held together) by the resin part 43.

In addition, owing to such an integral formation of the rotor 40, the end-surface fixing part 430, the plurality of first fixing parts 431, the plurality of second fixing parts 432, and the plurality of outer-circumference fixing parts 433 are integrally formed in the resin part 43. In other words, the permanent magnets 42 are securely (robustly) fixed (held) in an integrated manner to (in) the rotor core 41 due to the resin part 43.

Thus, all structural elements (i.e., the plurality of first fixing parts 431, the plurality of second fixing parts 432, the plurality of outer-circumference fixing parts 433, and the end-surface fixing part 430) included in the resin part 43 are integrally formed together by an integral-formation manufacturing method. That is, the first fixing parts 431 are formed by curing or solidifying the resin or polymer that filled the plurality of first runners 421. The second fixing parts 432 are formed by curing or solidifying the resin or polymer that filled the plurality of second runners 422. The outer-circumference fixing parts 433 are formed by curing or solidifying the resin or polymer that filled the plurality of openings 423.

It is noted that, as shown in FIG. 12, D1 is the outer diameter of the rotor core 41, and H1 is the thickness of the rotor core 41. Outer diameter D1 and thickness H1 will be referred to again in the second embodiment of the present teachings described below.

### 2-1-4. Characteristics of the Motor

In addition to the various features of the motor 11 according to the present embodiment described above, the motor 11 further has the features described below.

That is, the motor 11 according to the present embodiment is configured so as to satisfy Equation (1) below.

$$Equation 1$$

$$\frac{R}{{( \frac{V in}{Ne} )}^{2}} < 433 \; 000000 \cdot {Vol}^{- 1.621} \qquad ( 1 )$$

In the above-mentioned Equation (1), R is the wire-to-wire resistance value (in mΩ) of the motor 11. The wire-to-wire resistance value is the magnitude of the wire-to-wire resistance of the motor 11. The wire-to-wire resistance may also be called the motor resistance; i.e. the terms “wire-to-wire resistance” and “motor resistance” are intended to be synonymous. The wire-to-wire resistance is, more specifically, the resistance between two of the terminals from among the first to third electric power terminals 31-33. In the present embodiment, the wire-to-wire resistance value between the first electric power terminal 31 and the second electric power terminal 32, the wire-to-wire resistance value between the second electric power terminal 32 and the third electric power terminal 33, and the wire-to-wire resistance value between the third electric power terminal 33 and the first electric power terminal 31 are all equal. R may be a wire-to-wire resistance value that is determined in advance during the design stage.

In the above-mentioned Equation (1), Vin is the rated-voltage value (V) of the motor 11. In the present embodiment, the rated-voltage value of the motor 11 is equal to the rated-voltage value of the battery 3A. Though merely one example, the rated-voltage value of the battery 3A according to the present embodiment is 36 V. Accordingly, in the present embodiment, Vin is 36 V.

In the above-mentioned Equation (1), Ne is the rotational speed (in krpm) of the motor 11 when the effective, induced-voltage value E (V) of the motor 11 is equal to the rated-voltage value of the motor 11. The effective induced voltage is described in detail below.

In the above-mentioned Equation (1), Vol is the volume (in mm³) of the stator 20. More specifically, Vol in the present embodiment is the volume of the stator core 21. The volume of the stator core 21 according to the present embodiment is an integrated value resulting from integrating the surface area of the core-end circle (in mm²) over the core length (in mm). The core-end circle is a circle in which outer diameter Ld (see FIG. 6) of the stator core 21 is taken as the diameter. The core length is length Ls (see FIG. 6) along the axial direction of the stator core 21. It is noted that, as shown in FIG. 2 and FIG. 3, projection members are discretely formed on the outer-circumferential surface of the back core 211 in the circumferential direction; however, as is clear from FIG. 6, outer diameter Ld is the outer diameter of the back core 211 with those projection members removed. As can be seen in FIG. 6, Ls is less than Ld, preferably 2·Ls≤Ld, preferably 3·Ls≤Ld, optionally 4·Ls≤Ld or 10·Ls≤Ld.

The effective, induced-voltage value E will now be explained in greater detail. First, back EMF will be explained. It is known, generally, that back EMF is generated in a stator-side coil when a rotor having permanent magnets rotates.

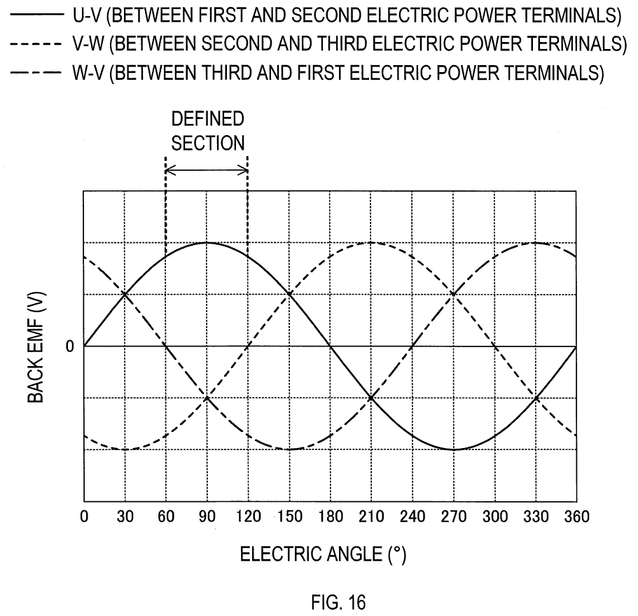

Likewise, in the motor 11 according to the present embodiment, back EMF is generated (occurs, arises) in each of the six coils 25 when the rotor 40 rotates; in turn, as shown in the illustrative example in FIG. 16, back EMF is generated (occurs, arises) between each pair of two of the terminals from among the first to third electric power terminals 31-33.

Here, as shown in the illustrative example in FIG. 16, a prescribed electrical-angle range, which includes the electrical angle (90° between U and V) at which back EMF becomes the largest, is defined as a defined section (interval). In the present embodiment, the width of electrical angle of the defined section (interval) is 60°. However, the width of the electrical angle may be different than 60°. For example, the width of the electrical angle may be selected, e.g., from the range of 40-90°.

In the present embodiment, the average value of the back EMF within this defined section (interval) is treated as the effective, induced-voltage value.

As shown in Equations (2) and (3) below, the left side of the above-mentioned Equation (1) is defined as “first characteristic value fa”, and the right side of the above-mentioned Equation (1) is defined as “second characteristic value fb”.

$$Equation 2 and 3$$

$$fa = \frac{R}{{( \frac{V in}{Ne} )}^{2}} \qquad ( 2 )$$

$$fb = 433000000 \cdot {Vol}^{- 1.621} \qquad ( 3 )$$

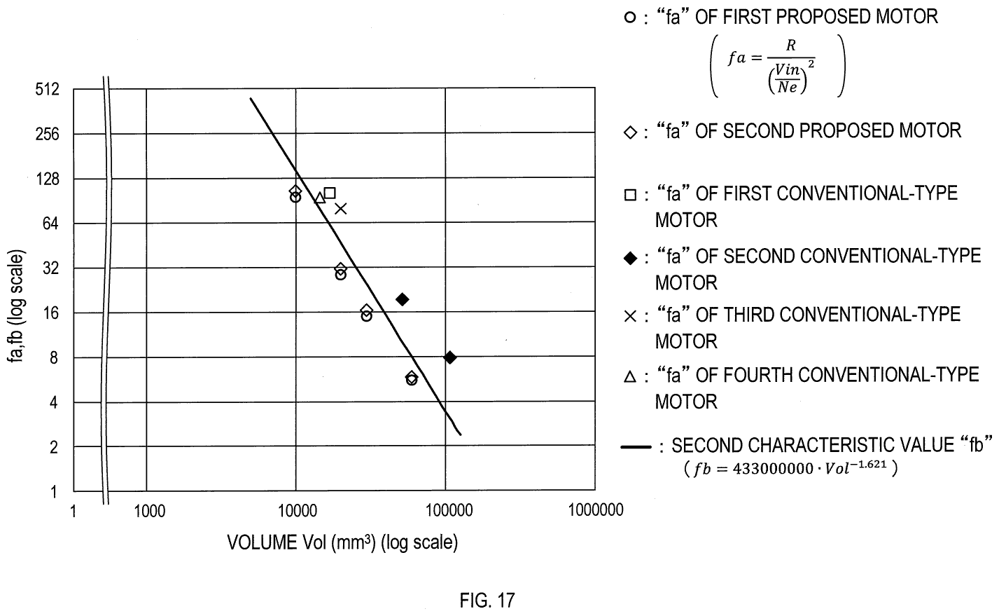

FIG. 17 shows an example of first characteristic values fa and second characteristic values fb calculated for each of thirteen motors. The thirteen motors are: four first proposed motors; four second proposed motors; a first conventional-type motor; two second conventional-type motors; a third conventional-type motor; and a fourth conventional-type motor. The parameters for each motor are shown in Table 1 below.

TABLE 1

| | | | Ld | Ls | Ne | E | Ke | R | Vol |
|---|---|---|---|---|---|---|---|---|---|
| | POLE | SLOT | (mm) | (mm) | (krpm) | (V) | (V/krpm) | (mΩ) | (mm³) |
| 1st P.M. | 8 | 6 | 50 | 5 | 25.0 | 36 | 1.44 | 196.1 | 9817 |
| | 8 | 6 | 50 | 10 | 25.0 | 36 | 1.44 | 59.8 | 19635 |
| | 8 | 6 | 50 | 15 | 25.0 | 36 | 1.44 | 31.1 | 29452 |
| | 8 | 6 | 50 | 30 | 25.0 | 36 | 1.44 | 11.5 | 58905 |
| 2nd P.M. | 8 | 6 | 50 | 5 | 25.0 | 36 | 1.44 | 219.2 | 9817 |
| | 8 | 6 | 50 | 10 | 25.0 | 36 | 1.44 | 63.9 | 19635 |
| | 8 | 6 | 50 | 15 | 25.0 | 36 | 1.44 | 33.6 | 29452 |
| | 8 | 6 | 50 | 30 | 25.0 | 36 | 1.44 | 12.0 | 58905 |
| 1st C.M. | 4 | 6 | 44 | 11 | 31.2 | 36 | 1.15 | 133.9 | 16726 |
| 2nd C.M. | 4 | 6 | 52 | 24 | 25.0 | 36 | 1.44 | 39.8 | 50969 |
| | 4 | 6 | 52 | 50 | 21.1 | 36 | 1.71 | 22.8 | 106186 |
| 3rd C.M. | 4 | 6 | 50 | 10 | 30.8 | 18 | 0.58 | 27.2 | 19635 |
| 4th C.M. | 4 | 6 | 51 | 7 | 25.9 | 18 | 0.70 | 44.9 | 14300 |

In Table 1, “1st P.M.” refers to the “first proposed motor”, “2nd P.M.” refers to the “second proposed motor,” “1st C.M.” refers to the “first conventional-type motor,” “2nd C.M.” refers to the “second conventional-type motor,” “3rd C.M.” denotes the “third conventional-type motor,” and “4th C.M.” denotes the “fourth conventional-type motor.” “Ke” is a back-EMF constant.

The first and second proposed motors both correspond to the motor 11 of the present first embodiment. That is, the first and second proposed motors both have at least the below-mentioned Features (a)-(c):
(a) the motor comprises eight (or 4m) magnetic poles and six (or 3m) slots (i.e, wherein m equals 2);
(b) thickness Dt of each of the core sheets 400 is 0.35 mm or less; and
(c) the motor is configured to be able to rotate at an electric frequency of 1,333 Hz or more.

It is noted that a point of difference between the first and second proposed motors is the widths of the permanent magnets. That is, the width of the permanent magnets 42 of the second proposed motor is smaller than the width of the permanent magnets 42 of the first proposed motor. Here, the “width” of the permanent magnets 42 is the dimension of the permanent magnet 42 in a direction perpendicular to both the axial direction and the radial direction, similar to the minimum width Wt described above.

In contrast, the first to fourth conventional-type motors do not have at least Feature (a) among the above-mentioned Features (a) to (c). Specifically, the first to fourth conventional-types motors are all 4-pole 6-slot motors. Regarding (b) above, the thickness Dt of each of the first proposed motors is 0.25 mm. The thickness Dt of each of the other nine motors is 0.35 mm. The rated-voltage value of each of the third conventional-type motor and the fourth conventional-type motor is 18 V, and the rated voltage value of each of the other eleven motors is 36 V.

It is noted that the length and/or winding count of the coils vary with volume Vol. Consequently, the wire-to-wire resistance value R can likewise vary with volume Vol. In addition, the magnetic characteristics (for example, the reluctance) of the stator and the rotor likewise vary with volume Vol. Consequently, the above-mentioned rotational speed Ne can likewise vary with volume Vol. Consequently, the first characteristic values fa of the differently designed motors likewise vary with volume Vol.

The first characteristic value fa is an indicator of the power density of each motor. The larger the line-to-line resistance value R, the lower the output of the motor. Therefore, the smaller the first characteristic value fa, the higher the output density. The second characteristic value fb is an indicator (or threshold) for evaluating the first characteristic value fa. For a motor having a given volume Vol, when the first characteristic value fa is smaller than the second characteristic value fb, the power density of the motor is high. When the first characteristic value fa is larger than the second characteristic value fb, the power density of the motor is low.

As is clear from FIG. 17, the first characteristic values fa of the first proposed motors and the first characteristic values fa of the second proposed motors are smaller (less) than the corresponding second characteristic values fb thereof. That is, the first characteristic values fa of the first and second proposed motors are less than the second characteristic values fb of the first and second proposed motors, respectively, as can be seen in FIG. 17 where the first characteristic values fa of the first and second proposed motors fall below the solid line that indicates the corresponding second characteristic values fb of the first and second proposed motors, respectively. Thus, both the first and second proposed motors satisfy the above-mentioned Equation (1). Consequently, a desired power density can be achieved by a motor 11 that satisfies the above-mentioned Equation (1) without requiring an enlargement of the motor 11.

In contrast, the first characteristic values fa of the first to fourth conventional-type motors are larger (greater) than the corresponding second characteristic values fb thereof. That is, as can be seen in FIG. 17, the first characteristic values fa of the first to fourth conventional-type motors fall above the solid line that indicates the corresponding second characteristic values fb of the first and second conventional-type motors, respectively. Therefore, none of the first to fourth conventional-type motor satisfies the above-mentioned Equation (1). Consequently, in embodiments in which volumes Vol are assumed to be the same, each of the first and second conventional-type motors have a lower power density than that of the first and second proposed motors.

### 2-1-5. Technical Effects of First Embodiment

The technical effects recited below are exhibited by the first embodiment explained above.

The motor 11 comprises Features (a)-(c) described in 2-1-4, and thus has a high power density. Consequently, enlargement of the motor 11 is not needed to be able to drive the motor 11 at high speed with high output. It is noted that these kinds of effects can be obtained even without Feature (b).

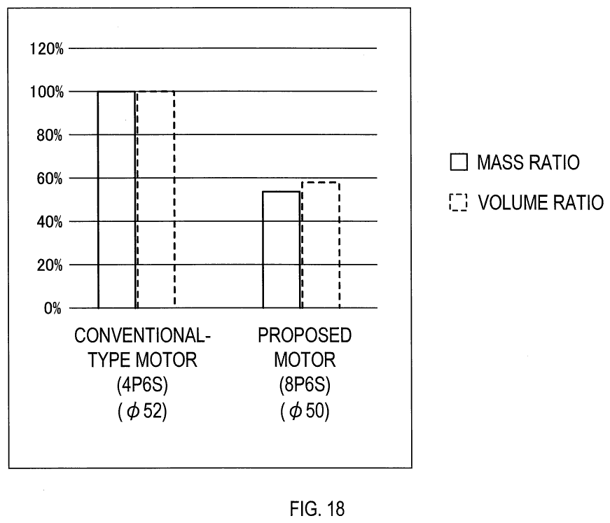

A supplemental explanation regarding the size of the motor 11 is provided using FIG. 18. FIG. 18 is a graph showing comparative examples of mass and volume of a conventional-type motor and a proposed motor, respectively. Specifically, FIG. 18 shows the ratio of the mass ratio and the volume ratio for both the conventional-type motor and the proposed motor. The mass ratio of the conventional-type motor is the ratio of the mass of the conventional-type motor to a reference mass. The reference mass is the mass of the conventional-type motor. The volume ratio of the conventional-type motor is the ratio of the volume of the conventional-type motor to a reference volume. The reference volume is the volume of the conventional-type motor. Accordingly, both the mass ratio and the volume ratio of the conventional-type motor are 100%. The mass ratio of the proposed motor is the ratio of the mass of the proposed motor to the reference mass. The volume ratio of the proposed motor is the ratio of the volume of the proposed motor to the reference volume. It is noted that “volume” as mentioned here is the same as volume Vol described above and is the volume of the stator.

The conventional-type motor and the proposed motor have the same back-EMF constants Ke and the same wire-to-wire resistance values R. The conventional-type motor and the proposed motor have equivalent output capacities. Back-EMF constant Ke indicates (is defined as) the ratio between the back-EMF value and the rotational speed. The present embodiment defines back-EMF constant Ke according to the below-mentioned Equation (4).

$$Equation 4$$

$$ke = \frac{E}{Na} \qquad ( 4 )$$

In the above-mentioned Equation (4), E (V) is the effective induced voltage. Na (krpm) is the rotational speed generated by that effective induced voltage E. That is, back-EMF constant Ke is defined based on effective induced voltage E generated (occurring, arising) when the rotor is rotating at rotational speed Na.

As described above, the back-EMF constants Ke of the conventional-type motor and the proposed motor are equal, and the wire-to-wire resistance values R of the conventional-type motor and the proposed motor are equal. In contrast to that, the conventional motor-type and the proposed motor differ in the following points.

The proposed motor comprises Features (a)-(c) described above. Specifically, the proposed motor has eight magnetic poles and six slots. In addition, the outer diameter (i.e., the outer diameter of the stator) is 50 mm.

In contrast, the conventional-type motor does not comprise Features (a)-(c) described above. Specifically, the conventional-type motor has four magnetic poles and six slots. In addition, the outer diameter of the conventional-type motor is 52 mm.

As is clear from FIG. 18, the mass and the volume of the proposed motor are smaller than those of the conventional-type motor. In other words, in order for the conventional-type motor to provide a performance that is equivalent to that of the proposed motor, the volume and the mass of the conventional-type motor must be made larger than those of the proposed motor.

Thickness Dt of each of the core sheets 400 of the present first embodiment is 0.35 mm. As described above, thickness Dt may be 0.30 mm or less or may be 0.25 mm or less. By forming the rotor core 41 from these kinds of thin core sheets 400, losses (for example, eddy-current losses) in the motor can be curtailed (reduced). Thereby, even higher speeds and/or higher outputs of the motor can be achieved while avoiding the need to enlarge the motor (as compared to conventional-type motors).

In addition, as explained with reference to FIG. 13, thickness Dt of each of the core sheets 400 according to the present embodiment is 0.35 mm or less. Consequently, compared with an embodiment in which thickness Dt is greater than 0.35 mm, the losses (for example, eddy-current loss) arising in the rotor core 41 are reduced. Thereby, the rotational speed and/or the output of the motor 11 can be further increased while avoiding the need to enlarge the motor 11.

In addition, as explained above with reference to FIG. 13, each of the core sheets 400 comprises the protruding portion 45 and the recessed portion 46. Furthermore, in the process of laminating the plurality of core sheets 400, the protruding portion 45 of one of the two mutually opposing core sheets 400 is inserted into the corresponding recessed portion 46 of the other of the two mutually opposing core sheets 400. Then, the protruding portions are respectively clinched to the recessed portions 46 by those insertions. Consequently, the core sheets 400 can be laminated securely and precisely during the laminating process. Thereby, it becomes possible for a high quality rotor core 41 to be provided, and in turn, it becomes possible for a high quality motor 11 to be provided.

In addition, as explained above with reference to FIG. 14, minimum width Wt of each of the connecting portions 41C of the rotor core 41 is preferably in the range of 0.4-0.6 mm. Consequently, reducing magnetic-flux short circuits and securely fixing the magnet-support parts 41B can both be achieved.

### 2-2. Second Embodiment

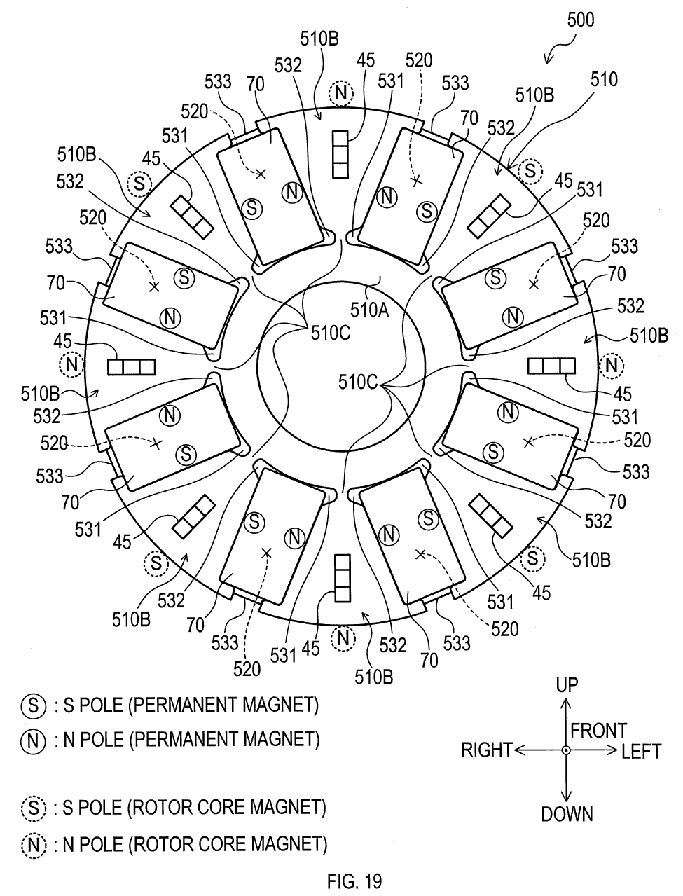

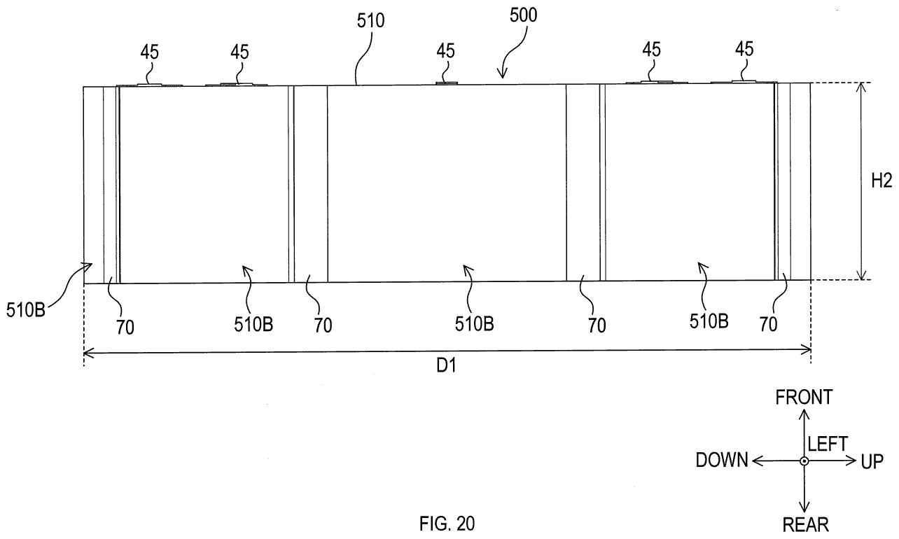

A second embodiment is an illustrative example of another embodiment of a rotor according to the present teachings. As shown in FIG. 19 and FIG. 20, the basic configuration for a rotor 500 of the second embodiment is the same as that of the rotor 40 of the first embodiment.

That is, the rotor 500 comprises a rotor core 510 and a plurality of permanent magnets 70. The rotor core 510 comprises a core ring 510A, a plurality of magnet-support parts 510B, and a plurality of connecting portions 510C. Similar to the first embodiment, the permanent magnets 70 are disposed (arranged) such that like poles oppose each other in the circumferential direction. Similar to the first embodiment, the rotor 500 is configured to comprise, for example, eight magnetic poles. Consequently, the rotor core 510 comprises eight of the permanent magnets 70, eight of the magnet-support parts 510B, and eight of the connecting portions 510C.

In addition, similar to the first embodiment, the rotor core 510 has a plurality of holes 520. The permanent magnets 70 are respectively inserted into the holes 520.

In addition, similar to the first embodiment, the rotor core 510 and the permanent magnets 70 are integrally molded with each other by a resin part. The resin part, similar to the resin part 43 of the first embodiment, comprises a plurality of first fixing parts 531, a plurality of second fixing parts 532, a plurality of outer-circumference fixing parts 533, and an end-surface fixing part (not shown).

The differences between this kind of rotor 500 and the rotor 40 of the first embodiment are principally (i) the thickness of the rotor core 510 and (ii) the width of each of the permanent magnets 70.

As shown in FIG. 20, the outer diameter of the rotor core 510 is equal to the outer diameter of the rotor core 41 of the first embodiment and is D1.

In contrast, the thickness (axial length) of the rotor core 510 is H2. H2 is larger than thickness H1 in the first embodiment. Furthermore, the width of each of the permanent magnets 70 is smaller than the width of each of the permanent magnets 42 of the first embodiment. Here, the width of the permanent magnets 42, 70 is taken in a plane that is parallel to the rotational axis of the rotor 40, 500 and is perpendicular to a radial direction of the rotor 40, 500.

That is, when taking the dimensions of the rotor core in the radial direction as constant (i.e. the diameter (D1) is constant), the larger the thickness (axial length) of the rotor core is, the smaller the width of each of the permanent magnets may (should) be, as will be further explained below. It is noted that a depiction of the resin part is omitted from FIG. 20 in order to simplify the explanation.

When the rotor core is made thicker (axially longer), magnetic forces due to the permanent magnets become larger, and consequently there is a possibility that the stator will resonate during operation and generate noise. Accordingly, in an embodiment in which the thickness (axial length) of the rotor core is increased, by making the width of each of the permanent magnets suitably smaller in accordance with (e.g., proportional to) the thickness of (axial length) the rotor core, noise caused by resonating of the stator can be curtailed while ensuring the desired rotational speed and/or the desired motor output.

### 2-3. Third Embodiment

A third embodiment according to the present teachings is an illustrative example of another shape and arrangement of the permanent magnets. As shown in FIG. 21, each group of a plurality of groups of the permanent magnets 141 according to the third embodiment comprises a first partial magnet 141A and a second partial magnet 141B.

In a first group of the permanent magnets 141, the first partial magnet 141A and the second partial magnet 141B are disposed: (i) mutually spaced apart in the circumferential direction; and (ii) such that unlike poles oppose each other in the circumferential direction.

A rotor core 150 comprises a core ring 150A, a plurality of magnet-support parts 150B, and a plurality of connecting portions 150C. Similar to the first embodiment, the rotor core 150 is configured to comprise, for example, eight magnetic poles. Consequently, the rotor core 150 comprises eight groups of the permanent magnets 141, eight of the magnet-support parts 150B, and eight of the connecting portions 150C.

A first hole 151 and a second hole 152 for disposing the respective permanent magnets 141 are provided in the rotor core 150 for each of the permanent magnets 141. More specifically, the first partial magnet 141A is inserted into the first hole 151, and the second partial magnet 141B is inserted into the second hole 152.

The first partial magnet 141A and the second partial magnet 141B, which constitute one group of the permanent magnets 141, are disposed such that the cross sections orthogonal to the axial direction are arranged to substantially have a V shape. That is, the first partial magnet 141A extends slightly tilted from the radial direction, and the second partial magnet 141B likewise extends slightly tilted from the radial direction. For example, the first and second partial magnets 141A, 141B may be tilted from the radial direction by an angle of 20° or less, e.g., e.g., 15° or less, e.g., 10° or less.

A first runner 151A is formed between an inner-circumferential surface of the first hole 151 and the first partial magnet 141A, and a first fixing part 161 is filled in that first runner 151A. A second runner 152A is formed between an inner-circumferential surface of the second hole 152 and the second partial magnet 141B, and a second fixing part 162 is filled in that second runner 152A.

In addition, each of the openings in the rotor core 150 is covered by an outer-circumference fixing part 163.

Similar to the first fixing parts 431, the second fixing parts 432, and the outer-circumference fixing parts 433 according to the first embodiment, one of the first fixing parts 161, one of the second fixing parts 162, and one of the outer-circumference fixing parts 163 are respectively one portion of one of the resin parts and are formed when the plurality of groups of the permanent magnets 141 are being integrally molded with the rotor core 150 by forming the resin part, e.g., in an insert molding process.

### 2-4. Fourth Embodiment

In the first embodiment, an illustrative example of the motor 11 having an 8-pole/6-slot arrangement was described. However, motors according to the present disclosure can have any arrangement as long as the arrangement satisfies the combination of 4m magnetic poles and 3m slots. For example, the motor may have a 4-pole/3-slot arrangement, a 12-pole/9-slot arrangement, or a 16-pole/12-slot arrangement.

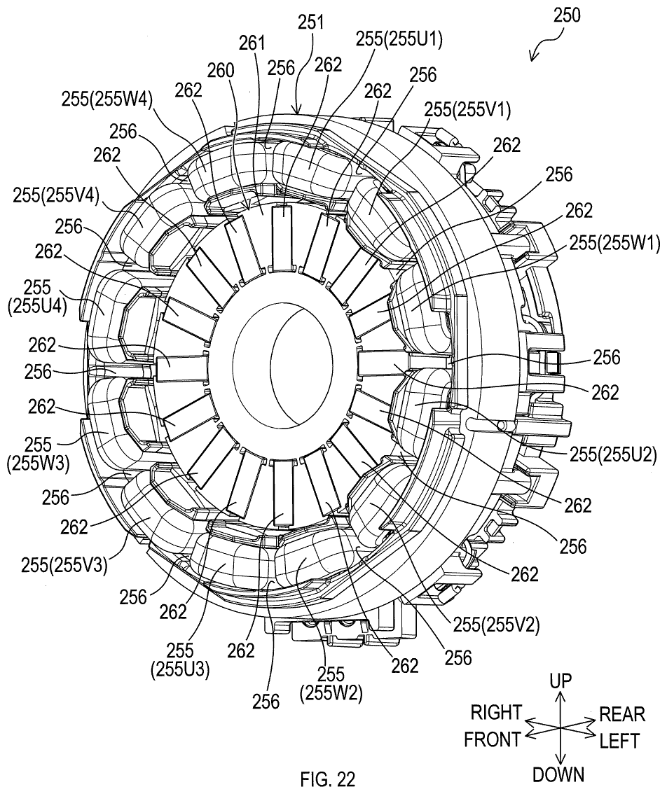

FIG. 22 shows an illustrative example of a motor 250 having a 16-pole/12-slot arrangement. It is noted that, in FIG. 22, the depiction of several parts, such as the rotor shaft, the sensor board, etc., is omitted.

The motor 250 comprises a rotor 260 and a stator 251.

The stator comprises twelve slots 256 and twelve coils 255. The twelve coils 255 can be partitioned into a first-phase coil group, a second-phase coil group, and a third-phase coil group. The first-phase coil group comprises first-phase coils 255U1, 255U2, 255U3, 255U4. These four coils may, for example, be mutually connected in parallel. The second-phase coil group comprises second-phase coils 255V1, 255V2, 255 V3, 255V4. These four coils may, for example, be mutually connected in parallel. The third-phase coil group comprises third-phase coils 255W1, 255W2, 255W3, 255W4. These four coils may, for example, be mutually connected in parallel. Furthermore, the first-phase coil group, the second-phase coil group, and the third-phase coil group are, for example, delta-connected to each other. Furthermore, similar to the first embodiment, the first-phase coil group, the second-phase coil group, and the third-phase coil group are electrically connected to the first to third electric power terminals 31-33 (see FIG. 15), respectively.

The rotor 260 comprises a rotor core 261 and sixteen permanent magnets 262. Similar to the first embodiment, the sixteen permanent magnets 262 are disposed such that like poles oppose each other in the circumferential direction.

### 2-5. Other Embodiments

Although embodiments of the present disclosure have been explained above, the present disclosure is not limited to the embodiments described above, and various modifications can be made and implemented.

(1) FIG. 13 shows one example of the protruding portions 45 and the recessed portions 46 on each of the core sheets 400. However, the protruding portions 45 and the recessed portions 46 may each have any kind of (complementary) shape.

In addition, the combination of the protruding portions 45 and the recessed portions 46 may be provided at any location on one core sheet 400, and any number of combinations may be provided.

In addition, two of the core sheets 400 may be fixed to each other by a method different from the above-described method for combining (joining, laminating) the protruding portions 45 and the recessed portions 46.

(2) The electric work machine 1 according to the above-mentioned first embodiment is configured as a power impact driver. However, the electric work machine 1 may be another type of power tool that is different from a power impact driver. More specifically, the electric work machine 1 may be any type of power tool, which comprises an electric motor, configured to be used at a work site such as in building construction, manufacturing, gardening, civil engineering, or the like, as described above.

The electric work machine 1 may be configured to be drivable by receiving AC electrical power from an AC power supply via a power cord instead of or in addition to the battery pack 3.

In addition, the present disclosure is likewise applicable to electric work machines for which the tool accessory is fixed in a non-detachable manner (or in a manner in which detachment is difficult).

### 2-6. Supplemental Notes

In the above-mentioned embodiments, a plurality of functions achieved by a single structural element may be achieved by a plurality of structural elements, and a single function achieved by a single structural element may be achieved by a plurality of structural elements. In addition, a plurality of functions achieved by a plurality of structural elements may be achieved by a single structural element, and a single function achieved by a plurality of structural elements may be achieved by a single structural element. In addition, one portion of the configuration of the above-mentioned embodiments may be omitted. In addition, at least one portion of the configuration of one of the above-mentioned embodiments may be added to or replaced by the configuration of another one of the above-mentioned embodiments.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, as was indicated above, each of the additional features and teachings disclosed above may be utilized separately or in conjunction with other features and teachings to provide improved electric work machines, such as cordless or corded power tools and outdoor power equipment, as well as method of manufacturing and using the same.

Moreover, as indicated above, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1 Electric work machine
3 Battery pack
6 Battery-mounting part
7 Second power-transmission part
11,250 Motors
12 First power-transmission part
13 Controller
15 Tool accessory
20, 251 Stators
21 Stator core
25, 255 Coils
26, 256 Slots
31 First electric power terminal
32 Second electric power terminal
33 Third electric power terminal
40, 260, 500 Rotors
41, 150, 261, 510 Rotor cores
41A, 150A, 510A Core rings
41B, 150B, 510B Magnet-support parts
41C, 150C, 510C Connecting portions
42, 70, 141, 262 Permanent magnets
45 Protruding portion
46 Recessed portion
141A First partial magnet
141B Second partial magnet
400 Core sheet
400A First surface
400B Second surface

What is claimed is:

1. An electric work machine, comprising:
a brushless motor; and
a motive-power transmitting part configured to (i) have a tool accessory mounted thereon or therein in a detachable or non-detachable manner, and (ii) transmit rotational energy of a rotor of the brushless motor to the tool accessory and thereby drive the tool accessory;
wherein:
the brushless motor comprises:
the rotor comprising a rotor core and a plurality of permanent magnets, wherein the permanent magnets: (i) are mutually spaced apart in a circumferential direction of the rotor core, and (ii) are disposed such that like poles oppose each other in the circumferential direction and thereby form a plurality of magnetic poles at or around an outer circumference of the rotor core in the circumferential direction; and
a stator comprising a plurality of coils respectively disposed in a plurality of slots defined in a stator core;
the number of magnetic poles is 4m;
the number of slots is 3m;
m is a natural number; and
the brushless motor is configured to rotate the rotor at an electric frequency of 1,333 Hz or more.

2. The electric work machine according to claim 1, wherein:
the rotor core comprises or is composed of a plurality of core sheets, the core sheets: (i) each including or being composed of a sheet-shaped, soft magnetic material, and (ii) being laminated along a rotational axis of the rotor; and
each of the core sheets has a thickness (Dt) in a direction along the rotational axis of the rotor in the range of 0 mm<Dt≤0.35 mm.

3. The electric work machine according to claim 2, wherein the thickness of each of the core sheets is 0.30 mm or less.

4. The electric work machine according to claim 3, wherein the thickness of each of the core sheets is 0.25 mm or less.

5. The electric work machine according to claim 2, wherein:
each of the core sheets has:
a first surface, on which a protruding portion is provided; and
a second surface, on which a recessed portion is provided at a location overlapping the protruding portion in the direction along the rotational axis of the rotor; and
the core sheets are laminated together by inserting the protruding portion of one of two mutually opposing core sheets into the corresponding recessed portion of the other of the two mutually opposing core sheets.

6. The electric work machine according to claim 1, wherein:
the rotor core has a plurality of holes disposed mutually spaced apart in the circumferential direction; and
the permanent magnets are respectively inserted in the plurality of holes.

7. The electric work machine according to claim 6, wherein:
the rotor core comprises:
a circular-tube-shaped core ring;
a plurality of magnet-support parts disposed mutually spaced apart in the circumferential direction, wherein the holes are respectively defined between each pair of two circumferentially adjacent ones of the magnet-support parts; and
a plurality of connecting portions respectively connecting the magnet-support parts to the core ring;
wherein:
each of the connecting portions has a smallest width (Wt) in the range of 0.4-0.6 mm; and
the smallest width (Wt) is a dimension of the connecting portion that extends perpendicular to a rotational axis of the rotor and perpendicular to a radial direction of the rotor.

8. The electric work machine according to claim 6, wherein:
the rotor core has a plurality of openings arranged in an outer-circumferential surface of the rotor core mutually spaced apart in the circumferential direction; and
the openings are respectively connected to the plurality of holes.

9. The electric work machine according to claim 1, wherein:
the brushless motor is configured to satisfy Equation (1) below; and
in Equation (1) below:
R is the wire-to-wire resistance value (in mΩ) of the brushless motor based on the plurality of coils;
Vin is the rated-voltage value (V) of the brushless motor;
Ne is the rotational speed (in krpm) of the brushless motor when a prescribed effective, induced-voltage value, which corresponds to the magnitude of a back EMF generated in the plurality of coils, is equal to the rated-voltage value; and
Vol is the volume (in mm³) of the stator; and
Equation (1) is:
$$\frac{R}{{( \frac{V in}{Ne} )}^{2}} < 433 \; 000000 \cdot {Vol}^{- 1.621} \qquad ( 1 )$$

10. The electric work machine according to claim 1, wherein:
the number of magnetic poles is eight; and
the number of slots is six.

11. The electric work machine according to claim 1, wherein the brushless motor is configured to rotate the rotor at a rotational speed of 20,000 rpm or more.

12. The electric work machine according to claim 1, wherein each of the permanent magnets has a longest dimension that extends along a radial direction of the rotor core or is tilted from the radial direction by an angle of 15° or less.

13. The electric work machine according to claim 1, wherein:
each of the permanent magnets includes a first partial magnet and a second partial magnet; and
the first partial magnet and the second partial magnet are disposed (i) mutually spaced apart in the circumferential direction, and (ii) such that unlike poles oppose each other in the circumferential direction.

14. The electric work machine according to claim 1, further comprising:
a grip portion configured to be gripped by a user of the electric work machine; and/or
a battery-mounting part configured to have a battery pack, which comprises a battery, mounted thereon in a detachable manner.

15. The electric work machine according to claim 2, wherein:
the rotor core has a plurality of holes disposed mutually spaced apart in the circumferential direction;
the permanent magnets are respectively inserted in the plurality of holes;
the rotor core comprises:
a circular-tube-shaped core ring;
a plurality of magnet-support parts (i) disposed mutually spaced apart in the circumferential direction, and (ii) wherein the holes are respectively defined between each pair of two circumferentially adjacent ones of the magnet-support parts; and
a plurality of connecting portions respectively connecting the magnet-support parts to the core ring;
wherein:
each of the connecting portions has a smallest width in the range of 0.4-0.6 mm; and
the smallest width is a dimension of the connecting portion that extends perpendicular to the rotational axis of the rotor and perpendicular to a radial direction of the rotor.

16. The electric work machine according to claim 15, wherein:
the brushless motor is configured to satisfy Equation (1) below; and
in Equation (1) below:
R is the wire-to-wire resistance value (in m Ω) of the brushless motor based on the plurality of coils;
Vin is the rated-voltage value (V) of the brushless motor;
Ne is the rotational speed (in krpm) of the brushless motor when a prescribed effective, induced-voltage value, which corresponds to the magnitude of a back EMF generated in the plurality of coils, is equal to the rated-voltage value; and
Vol is the volume (in mm³) of the stator; and
Equation (1) is:
$$\frac{R}{{( \frac{V in}{Ne} )}^{2}} < 433 \; 000000 \cdot {Vol}^{- 1.621} \qquad ( 1 )$$

17. The electric work machine according to claim 16, wherein each of the permanent magnets has a longest dimension that extends along a radial direction of the rotor core or is tilted from the radial direction by an angle of 15° or less.

18. The electric work machine according to claim 17, further comprising:
a grip portion configured to be gripped by a user of the electric work machine; and
a battery-mounting part configured to have a battery pack, which comprises a battery, mounted thereon in a detachable manner;
wherein:
the number of magnetic poles is eight;
the number of slots is six; and
the brushless motor is configured to rotate the rotor at a rotational speed of 20,000 rpm or more.

19. A method of manufacturing an electric work machine, comprising:
preparing a rotor having 4m magnetic poles, wherein the rotor comprises a plurality of permanent magnets disposed such that like poles oppose each other in a rotational direction of the rotor, and m is a natural number;
preparing a stator having 3m slots; and
installing in the electric work machine a brushless motor, which comprises the rotor and the stator and is configured to rotate at an electric frequency of 1,333 Hz or more.

20. A brushless motor, comprising:
a rotor comprising a rotor core and a plurality of permanent magnets, wherein the permanent magnets: (i) are mutually spaced apart in a circumferential direction of the rotor core, and (ii) are disposed such that like poles oppose each other in the circumferential direction and thereby form a plurality of magnetic poles at or around an outer circumference of the rotor core in the circumferential direction; and
a stator comprising a plurality of coils respectively disposed in a plurality of slots defined in a stator core;
the number of magnetic poles is 4m;
the number of slots is 3m;
m is a natural number; and
the brushless motor is configured to rotate the rotor at an electric frequency of 1.333 Hz or more.
